(19) United States
(12) Patent Application Publication
(10) Pub. No.: US 2004/0022940 A1
(43) Pub. Date: Feb. 5, 2004

(54) Cooper-plating solution, plating method and plating apparatus

(76) Inventors: Mizuki Nagai, Fujisawa-shi (JP); Shuichi Okuyama, Ichinomiya-shi (JP); Ryoichi Kimizuka, Tokyo (JP); Takeshi Kobayashi, Fujisawa-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/257,265

(22) PCT Filed: Feb. 20, 2002
(86) PCT No.: PCT/JP02/01455

(30) Foreign Application Priority Data
Feb. 23, 2001 (JP) 2001-48377

(51) Int. Cl. B05D 3/10

(52) U.S. Cl. 427/230; 427/304; 118/400

(57) ABSTRACT

There is provided a copper-plating solution which, when used in plating of a substrate having an seed layer and fine recesses of a high aspect ratio, can reinforce the thin portion of the seed layer and ensures complete filling with copper of the fine recesses, and which is so stable that its performance is not lowered after a long-term continuous use thereof. The plating solution contains monovalent or divalent copper ions, a complexing agent, and an organic sulfur compound as an additive, and optionally a surfactant.

### TECHNICAL FIELD

This invention relates a copper-plating solution, a plating method and a plating apparatus, and more particularly to a copper-plating solution, a plating method and a plating apparatus useful for forming copper interconnects by plating a semiconductor substrate to fill with copper fine recesses for interconnects formed in the surface of the substrate.

### BACKGROUND ART

In recent years, instead of using aluminum or aluminum alloys as a material for forming interconnection circuits on a semiconductor substrate, there is an eminent movement towards using copper (Cu) which has a low electric resistance and high electromigration resistance. Copper interconnects are generally formed by embedding copper into fine recesses formed in the surface of a substrate. There are known various techniques for producing such copper interconnects, including CVD, sputtering, and plating. According to any such technique, a copper is deposited on the substantially entire surface of a substrate, followed by removal of unnecessary copper by chemical mechanical polishing (CMP).

FIGS. 19A through 19C illustrate, in a sequence of processing steps, an example of producing such a substrate W having copper interconnects. As shown in FIG. 19A, an oxide film 2 of SiO₂ is deposited on a conductive layer 1a formed on a semiconductor base 1 on which semiconductor devices are formed. A contact hole 3 and a trench 4 for interconnects are formed in the oxide film 2 by the lithography and etching technique. Thereafter, a barrier layer 5 of TaN or the like is formed on the entire surface, and a seed layer 7 as an electric supply layer for electroplating is formed on the barrier layer 5.

Then, as shown in FIG. 19B, copper plating is performed onto the surface of the substrate W to fill the contact hole 3 and the trench 4 with copper and, at the same time, deposit a copper film 6 on the oxide film 2. Thereafter, the copper film 6 and the barrier layer 5 on the oxide film 2 are removed by chemical mechanical polishing (CMP) so as to make the surface of the copper film 6 filled into the contact hole 3 and the trench 4 for interconnects and the surface of the oxide film 2 lie substantially on the same plane. An interconnect composed of the copper film 6, as shown in FIG. 19C is thus formed.

The seed layer 7 is generally formed by sputtering or CVD. In the case where the copper film 6 is formed by electroplating with copper, a copper sulfate plating liquid, which contains copper sulfate and sulfuric acid, has generally been used as a plating liquid.

With the recent trend towards finer interconnects, the trenches for interconnects or plugs are becoming to have a higher aspect ratio. This poses the problem that a seed layer cannot be sufficiently formed by, e.g. sputtering, in the bottom portion of the trench, thus failing to form a uniform seed layer. Thus, as shown in FIG. 20A, there is a likelihood that the thickness t₁ of the seed layer 7 formed on the side wall of the trench near the bottom portion thereof becomes 1/10 or less of the thickness t₂ of the seed layer 7 formed on the side wall of the trench near the surface of the substrate. When electroplating with copper is carried out to fill such a trench with copper by using a copper sulfate plating liquid, an electric current hardly passes through the extremely thin portion in the seed layer 7, causing to the formation of an undeposited portion (void) 8 shown in FIG. 20B. An attempt to overcome this drawback by increasing the overall thickness of the seed layer 7 so as to thicken the extremely thin portion would not be successful, since in electroplating with copper for filling such trench, copper would deposit thick around the opening of the trench to close it, resulting in the formation of a void.

On the other hand, a copper-plating liquid, which comprises a base such as copper sulfate and, as additives, a complexing agent and a pH adjusting agent for maintaining the liquid pH within a neutral range, has been developed. Such a copper-plating liquid, however, is generally too unstable for practical use.

### DISCLOSURE OF INVENTION

The present invention has been made in view of the above situation in the related art. It is therefore an object of the present invention to provide a copper-plating solution which can reinforce the thin portion of a seed layer and ensures complete filling with copper of fine recesses having a high aspect ratio, and which is so stable that its performance is not lowered after a long-term continuous use thereof, and also to provide a plating method and an apparatus which utilize the copper-plating solution. A plating method using a copper-plating solution according to the present invention can be applied to the so-called direct plating for depositing the plated film on the barrier layer direct.

In order to achieve the above object, the present invention provides a copper-plating solution comprising monovalent or divalent copper ions, a complexing agent, and an additive which restrains a copper chelate from taking off the chelate and depositing on the surface of a substrate.

The present invention also provides a copper-plating solution comprising monovalent or divalent copper ions, a complexing agent, and an organic sulfur compound as an additive.

The inclusion of a complexing agent in the copper-plating solution can enhance the polarization of the plating solution and improve the uniform electrodeposition property. This enables reinforcement of the thin portion of a seed layer and uniform filling of copper into the depth of fine recesses, such as trenches and via holes, having a high aspect ratio. Further, the deposited plating is dense, and is freed from microvoids formation therein.

Further, the use of an organic sulfur compound as an additive in the copper-plating solution makes it possible to carry out plating even onto a thinner underlying conductive layer (seed layer) (e.g. having a thickness, on the surface of a substrate, of 100 nm or less) than one with which plating has hitherto been possible. In addition, the copper-plating solution, due to the use of the organic sulfur compound as the additive, is excellent in the so-called bottom-up property, making it possible to fill with copper fine trenches or holes having such a high or severe aspect ratio that filling with copper has never been possible. It is considered in this regard that the organic sulfur component may restrain a copper chelate from taking off the chelate (ligand) and depositing on the surface of a substrate, whereby a larger amount of copper can be deposited in the depth of such fine trenches or holes.

The organic sulfur compound additive, due to its polarity, can be easily determined of its concentration by using an electrochemical measuring method, such as CVS method which is generally employed for measuring the concentration of an additive in a copper-plating solution. In addition, since the organic sulfur compound additive is very stable in the plating solution, the liquid management can be made with ease. The concentration of the organic sulfur compound additive is generally in the range of 0.1-500 mg/l, preferably 0.5-100 mg/l, more preferably 1-50 mg/l.

The concentration of copper ions in the copper-plating solution should preferably be in the range of 0.1-100 g/l. A copper ion concentration below the above range lowers the current efficiency, thereby lowering the precipitation efficiency of copper. A copper ion concentration exceeding the above range worsens the electrodeposition property of the plating solution. The concentration of the complexing agent should preferably be in the range of 0.1-500 g/l. When the concentration is lower than the above range, an adequate complexing with copper can hardly be made whereby sediments are likely to produce. When the concentration is higher than the above range, on the other hand, the plating can take on the so-called “burnt deposit” state and thus the appearance is worsened and, in addition, the treatment of waste liquid becomes difficult. The copper-plating solution may be maintained at a pH of 7-14, preferably at a pH of 8-10, more preferably at a pH of about 9. When the pH of the plating solution is too low, the complexing agent cannot effectively combine with copper, thus failing to provide a complete complex. On the other hand, too high a pH of the plating solution can bring about the formation of a variant form of complex which makes a sediment. The above-described pH range can obviate these drawbacks.

The organic sulfur compound is preferably one or more kinds of organic sulfide compounds or organic polysulfide compounds.

Organic sulfur compounds having a sulfonic or phosphonic group may contain in the molecule, in particular in the aromatic and/or heterocyclic sulfide-sulfonic or phosphonic acid structure, substituents such as methyl, bromo, chloro, methoxy, ethoxyl, carboxyl and hydroxyl groups. These compounds may be used in the form of a free acid, an alkali metal salt, an organic amine salt, etc. Preferred organic divalent sulfur compounds include HO₃P—(CH₂)₃—S—S—(CH₂)₃—PO₃H, mercaptane, thiocarbamate, thiolcarbamate, and thiocarbonate having at least one sulfonic or phosphonic group. Especially preferred organic divalent sulfur compounds are those organic polysulfide compounds having the general formula:

XR₁—(S)ₙ—R₂—SO₃Y or XR₁—(S)ₙ—R₂—PO₃Y

wherein R₁ and R₂, which may be the same or different, each represent an alkylene group, X represents hydrogen, SO₃H or PO₃H, Y represents hydrogen, and n is an integer from 2 to 6. The concentration of the organic sulfur compound additive described above is generally in the range of 1-100 mg/l.

The organic divalent sulfur compounds of the above formula are aliphatic polysulfides having in the molecule at least two adjacent divalent sulfur atoms and one or two terminal sulfonic or phosphonic acid groups. The alkylene moiety in the molecule may be substituted by methyl, bromo, chloro, methoxy, ethoxy, carboxyl, hydroxyl or other groups. These compounds may be used in the form of a free acid, an alkali metal salt, an organic amine salt, etc.

The plating solution may further contain a surfactant as an additive. The addition of surfactant can improve the wetting property of the plating solution so that the plating solution can more easily enter into a small hole and, in addition, can further restrain the deposition of copper on the surface of a substrate, thus further enhancing the property of filling copper into the depth of fine holes or trenches. Polyalkylene glycols, their EO (ethylene oxide) or PO (propylene oxide) adducts, i.e. polyether polyols, quaternary ammonium salts, etc. may be used as the surfactant.

The present invention also provides a method for plating a substrate having fine recesses covered with a seed layer to fill the fine recesses with a metal, comprising plating a surface of the substrate by bringing the surface of the substrate into contact with a plating solution, the plating solution comprising monovalent or divalent copper ions, a completing agent, and an organic sulfur compound as an additive.

This method can reinforce and complete thin portions possibly present in a seed layer with the copper plating and ensures complete filling of copper into trenches or via holes even with a high aspect ratio.

The present invention further provides a method for plating a substrate having fine recesses covered with a barrier layer to fill the fine recesses with a metal, comprising plating a surface of the substrate by bringing the surface of the substrate into contact with a plating solution, the plating solution comprising monovalent or divalent copper ions, a complexing agent, and an organic sulfur compound as an additive.

The present invention further provides a method for plating a substrate having fine recesses covered with a seed layer to fill the fine recesses with a metal, comprising: plating the surface of the substrate in a first-stage by bringing a surface of the substrate into contact with a first plating solution; and plating the surface of the substrate in a second-stage by bringing the surface of the substrate into contact with a second plating solution; wherein the first plating solution comprises monovalent or divalent copper ions, a completing agent, and an organic sulfur compound as an additive, and the second plating solution has a composition of excellent leveling properties.

The present invention further provides a method for plating a substrate having fine recesses covered with a barrier layer to fill the fine recesses with a metal, comprising: plating the surface of the substrate in a first-stage by bringing a surface of the substrate into contact with a first plating solution; and plating the surface of the substrate in a second-stage by bringing the surface of the substrate into contact with a second plating solution; wherein the first plating solution comprises monovalent or divalent copper ions, a complexing agent, and an organic sulfur compound as an additive, and the second plating solution has a composition of excellent leveling properties.

The present invention further provides a plating apparatus, comprising: a first plating section for carrying out a first-stage plating of a surface of a substrate having fine recesses covered with a barrier layer and/or a seed layer; a first plating solution feed section for feeding a first plating solution into a plating chamber in the first plating section; a second plating section for carrying out a second-stage plating of the surface of the substrate which has undergone the first-stage plating; a second plating solution feed section for feeding a second plating solution into a plating chamber in the second plating section; and a transfer section for transferring the substrate from the first plating section to the second plating section; wherein the first plating solution has a composition of excellent uniform electrodeposition properties and comprises monovalent or divalent copper ions, a complexing agent, and an organic sulfur compound as an additive, and the second plating solution has a composition of excellent leveling properties.

The above and other objects, features, and advantages of the present invention will be apparent from the following description when taken in conjunction with the accompanying drawings which illustrate preferred embodiments of the present invention by way of example.

### BRIEF DESCRIPTION OF DRAWINGS

FIG. 1 is a plan view of an embodiment of a plating apparatus;

FIG. 2 is a schematic view showing airflow in the plating apparatus shown in FIG. 1;

FIG. 3 is a cross-sectional view showing airflows among areas in the plating apparatus shown in FIG. 1;

FIG. 4 is a perspective view of the plating apparatus shown in FIG. 1, which is placed in a clean room;

FIG. 5 is a cross-sectional view showing a whole structure of a plating section at the time of plating process;

FIG. 6 is a schematic diagram showing a flow of a plating solution in a plating section;

FIG. 7 is a cross-sectional view showing a whole structure of the plating section at the time of non-plating process (at the time of transfer of a substrate);

FIG. 8 is a cross-sectional view showing a whole structure of the plating section at the time of maintenance;

FIG. 9 is a cross-sectional view explanatory of a relationship among a housing, a pressing ring, and a substrate at the time of transfer of a substrate;

FIG. 10 is an enlarged view showing a part of FIG. 9;

FIGS. 11A through 11D are schematic views explanatory of the flow of a plating solution at the time of plating process and at the time of non-plating process;

FIG. 12 is an enlarged cross-sectional view showing a centering mechanism in the plating section;

FIG. 13 is a cross-sectional view showing a feeding contact (probe) in the plating section;

FIG. 14 is a flow diagram showing the flow of process steps according to an embodiment of the plating method of the present invention;

FIG. 15 is a graph showing the relationship between the voltage and the current density in two different copper-plating solutions having different polarizations;

FIG. 16 is a flow diagram showing the flow of process steps according to another embodiment of the plating method of the present invention;

FIG. 17 shows current-voltage curves for the complex bath 7 when the amount of the organic sulfur compound (III-(4)) is varied as: 0 ppm, 1 ppm, 5 ppm, 10 ppm and 25 ppm;

FIG. 18A is a diagram showing a shape of a via hole to fill with copper by plating;

FIG. 18B is a diagram showing a bottom void observed under SEM;

FIG. 18C is a diagram showing a seam void observed under SEM;

FIGS. 19A through 19C are diagrams illustrating, in a sequence of process steps, the formation of copper interconnects through copper plating;

FIGS. 20A and 20B are cross-sectional views illustrating the state of a seed layer and a void which has been formed according to a conventional method;

FIG. 21 is a plan view of another example of a substrate plating apparatus;

FIG. 22 is a plan view of still another example of a substrate plating apparatus;

FIG. 23 is a plan view of still another example of a substrate plating apparatus;

FIG. 24 is a view showing a plan constitution example of the semiconductor substrate processing apparatus;

FIG. 25 is a view showing another plan constitution example of the semiconductor substrate processing apparatus;

FIG. 26 is a view showing still another plan constitution example of the semiconductor substrate processing apparatus;

FIG. 27 is a view showing still another plan constitution example of the semiconductor substrate processing apparatus;

FIG. 28 is a view showing still another plan constitution example of the semiconductor substrate processing apparatus;

FIG. 29 is a view showing still another plan constitution example of the semiconductor substrate processing apparatus;

FIG. 30 is a view showing a flow of the respective steps in the semiconductor substrate processing apparatus illustrated in FIG. 29;

FIG. 31 is a view showing a schematic constitution example of a bevel and backside cleaning unit;

FIG. 32 is a view showing a schematic constitution of an example of an electroless-plating apparatus;

FIG. 33 is a view showing a schematic constitution of another example of an electroless-plating apparatus;

FIG. 34 is a vertical sectional view of an example of an annealing unit; and

FIG. 35 is a transverse sectional view of the annealing unit.

### BEST MODE FOR CARRYING OUT THE INVENTION

Preferred embodiments of the present invention will be now described with reference to the drawings.

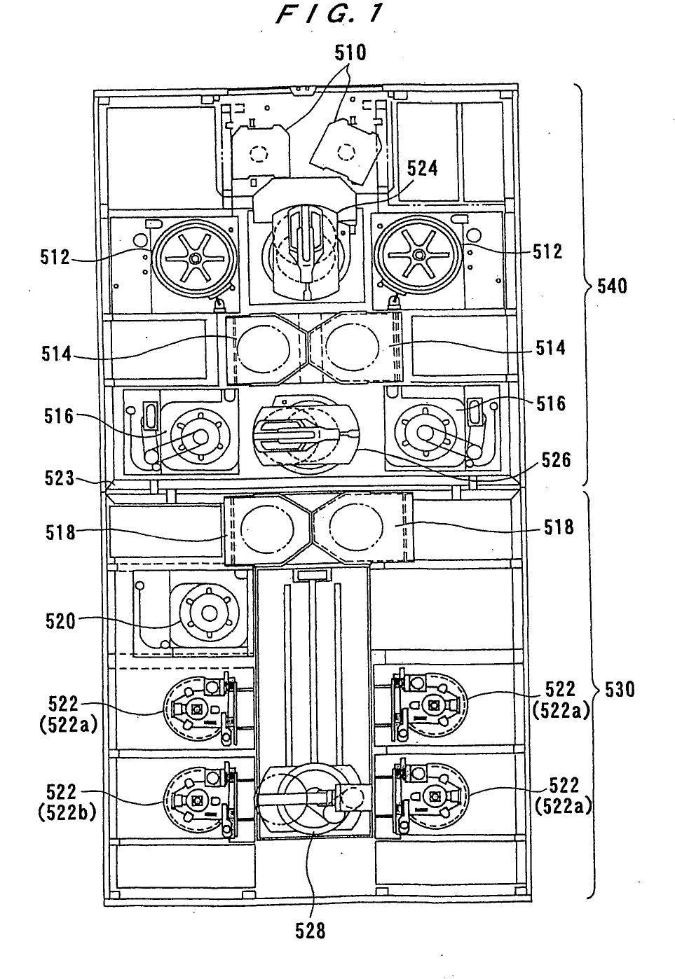

FIG. 1 is a plan view of an embodiment of a plating apparatus in accordance with the present invention. The plating apparatus comprises loading/unloading sections 510, each pair of cleaning/drying sections 512, first substrate stages 514, bevel-etching/chemical cleaning sections 516 and second substrate stages 518, a washing section 520 provided with a mechanism for reversing the substrate through 180°, and four plating sections 522. The plating apparatus is also provided with a first transferring device 524 for transferring a substrate between the loading/unloading sections 510, the cleaning/drying sections 512 and the first substrate stages 514, a second transferring device 526 for transferring a substrate between the first substrate stages 514, the bevel-etching/chemical cleaning sections 516 and the second substrate stages 518, and a third transferring device 528 for transferring the substrate between the second substrate stages 518, the washing section 520 and the plating sections 522.

The plating apparatus has a partition wall 523 for dividing the plating apparatus into a plating space 530 and a clean space 540. Air can individually be supplied into and exhausted from each of the plating space 530 and the clean space 540. The partition wall 523 has a shutter (not shown) capable of opening and closing. The pressure of the clean space 540 is lower than the atmospheric pressure and higher than the pressure of the plating space 530. This can prevent the air in the clean space 540 from flowing out of the plating apparatus and can prevent the air in the plating space 530 from flowing into the clean space 540.

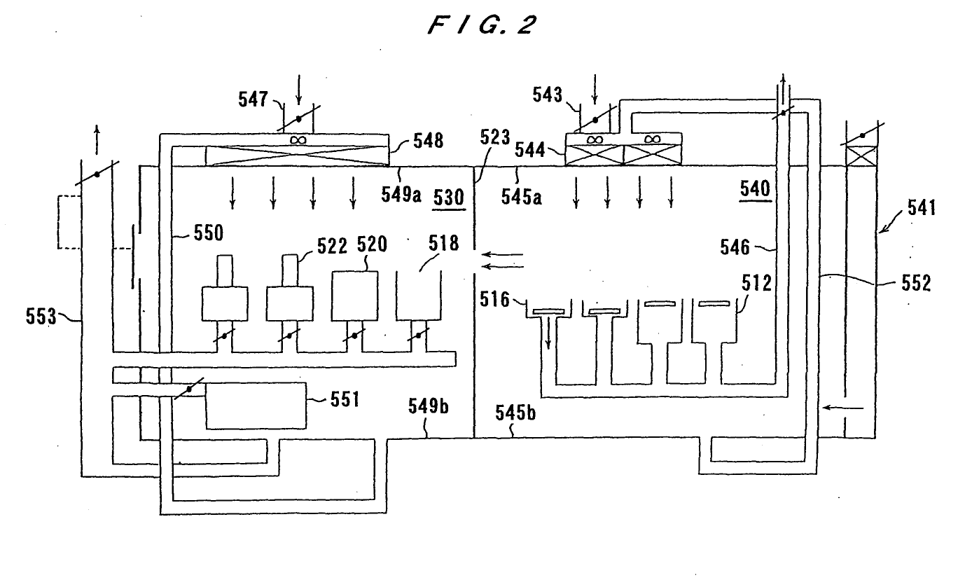

FIG. 2 is a schematic view showing an air current in the plating apparatus. In the clean space 540, a fresh external air is introduced through a pipe 543 and pushed into the clean space 540 through a high-performance filter 544 by a fan. Hence, a down-flow clean air is supplied from a ceiling 545a to positions around the cleaning/drying sections 512 and the bevel-etching/chemical cleaning sections 516. A large part of the supplied clean air is returned from a floor 545b through a circulation pipe 552 to the ceiling 545a, and pushed again into the clean space 540 through the high-performance filter 544 by the fan, to thus circulate in the clean space 540. A part of the air is discharged from the cleaning/drying sections 512 and the bevel-etching/chemical cleaning sections 516 through a pipe 546 to the exterior, so that the pressure of the clean space 540 is set to be lower than the atmospheric pressure.

The plating space 530 having the washing sections 520 and the plating sections 522 therein is not a clean space (but a contamination zone). However, it is not acceptable to attach particles to the surface of the substrate. Therefore, in the plating space 530, a fresh external air is introduced through a pipe 547, and a down-flow clean air is pushed into the plating space 530 through a high-performance filter 548 by a fan, for thereby preventing particles from being attached to the surface of the substrate. However, if the whole flow rate of the down-flow clean air is supplied by only an external air supply and exhaust, then enormous air supply and exhaust are required. Therefore, the air is discharged through a pipe 553 to the exterior, and a large part of the down-flow is supplied by a circulating air through a circulation pipe 550 extended from a floor 549b, in such a state that the pressure of the plating space 530 is maintained to be lower than the pressure of the clean space 540.

Thus, the air returned to a ceiling 549a through the circulation pipe 550 is pushed again into the plating space 530 through the high-performance filter 548 by the fan. Hence, a clean air is supplied into the plating space 530 to thus circulate in the plating space 530. In this case, air containing chemical mist or gas emitted from the washing sections 520, the plating sections 522, the third transferring device 528, and a plating liquid regulating tank 551 is discharged through the pipe 553 to the exterior. Thus, the pressure of the plating space 530 is controlled so as to be lower than the pressure of the clean space 540.

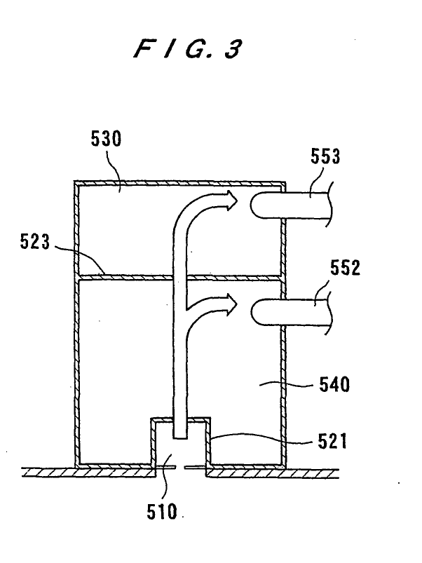

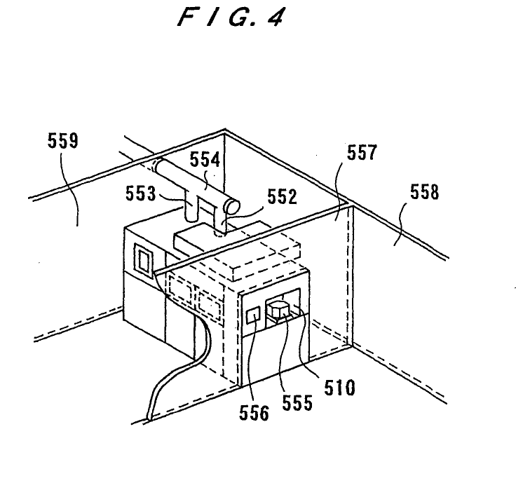

The pressure in the loading/unloading sections 510 is higher than the pressure in the clean space 540 which is higher than the pressure in the plating space 530. When the shutters (not shown) are opened, therefore, air flows successively through the loading/unloading sections 510, the clean space 540, and the plating space 530, as shown in FIG. 3. Air discharged from the clean space 540 and the plating space 530 flows through the ducts 552, 553 into a common duct 554 (see FIG. 4) which extends out of the clean room.

FIG. 4 shows a perspective view of the plating apparatus shown in FIG. 1, which is placed in the clean room. The loading/unloading sections 510 includes a side wall which has a cassette transfer port 555 defined therein and a control panel 556, and which is exposed to a working zone 558 that is compartmented in the clean room by a partition wall 557. The partition wall 557 also compartments a utility zone 559 in the clean room in which the plating apparatus is installed. Other sidewalls of the plating apparatus are exposed to the utility zone 559 whose air cleanness is lower than the air cleanness in the working zone 558.

FIG. 5 shows a main part of the plating section 522. The plating section 522 mainly comprises a plating process container 46 in the substantially cylindrical form for holding a plating solution 45 therein, and a head 47 disposed above the plating process container 46 for holding a substrate. In FIG. 5, the head 47 is located in a plating position in which a substrate W held by the head 47 is lowered and the liquid level of the plating solution 45 is raised.

The plating process container 46 comprises a plating container 50 which has a plating chamber 49. The plating chamber 49 is open upward and has an anode 48 at the bottom thereof, and contains the plating solution 45 therein. Plating solution supply nozzles 53, which project horizontally toward the center of the plating chamber 49, are disposed at circumferentially equal intervals on the inner circumferential wall of the plating container 50. The plating solution supply nozzles 53 communicate with plating solution supply passages extending vertically within the plating container 50.

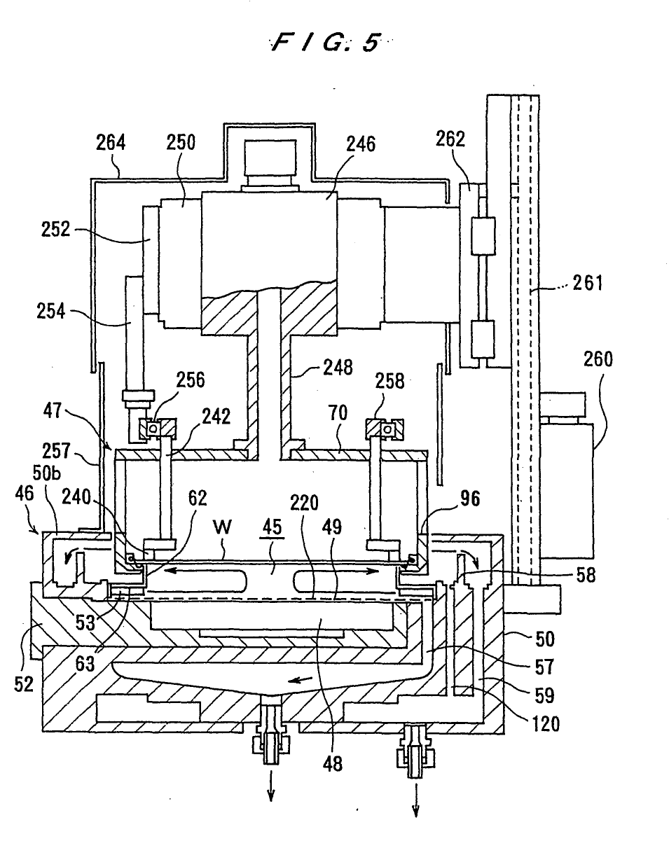

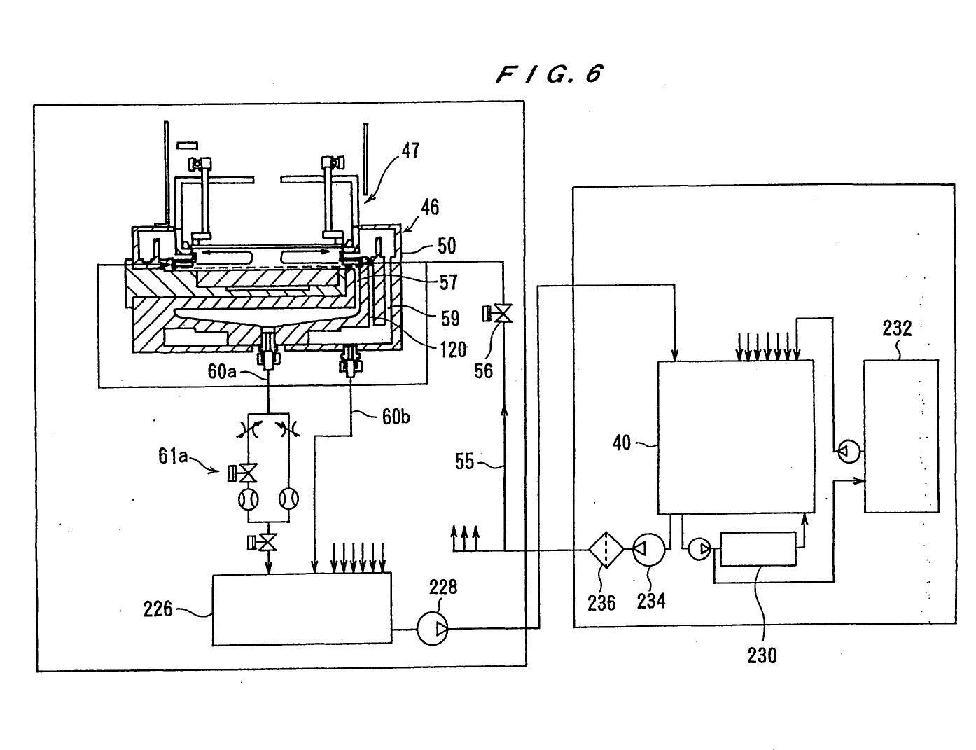

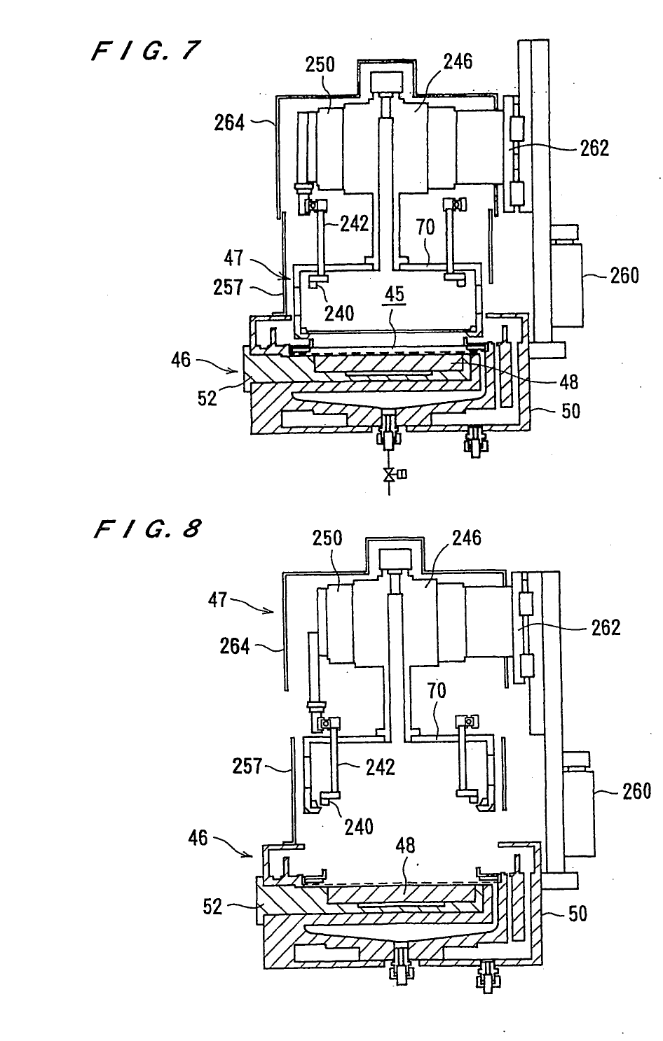

The plating solution supply passages are connected to the plating solution regulating tank 40, shown in FIG. 6, through the plating solution supply pipes 55. Control valves 56 for controlling the backpressure so as to be constant are disposed on each of the plating solution supply pipes 55.

Further, according to this embodiment, a punch plate 220 having a large number of holes with a size of, for example, about 3 mm is disposed at a position above the anode 48 within the plating chamber 49. The punch plate 220 prevents a black film formed on the surface of the anode 48 from curling up by the plating solution 45 and consequently being flowed out.

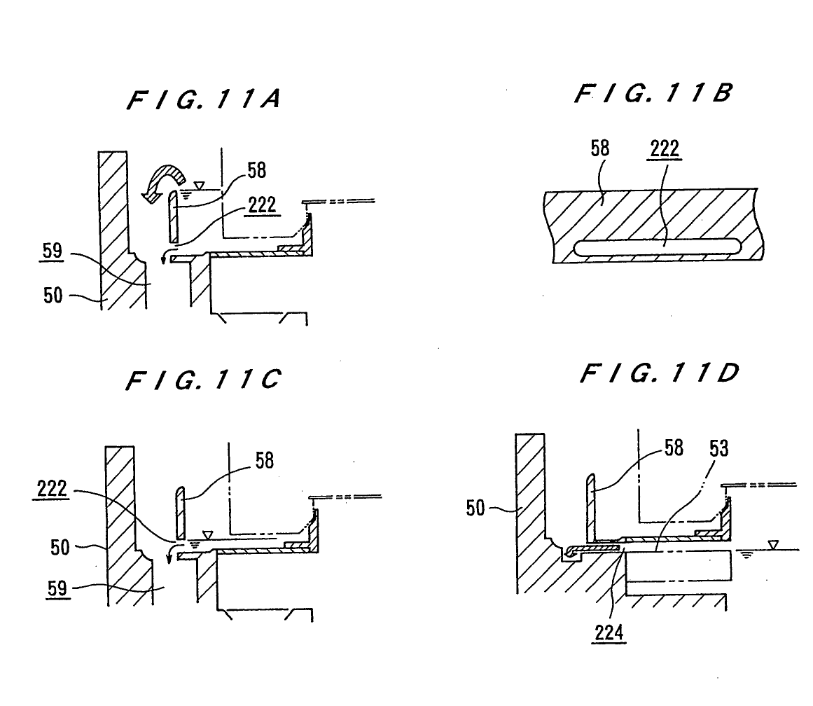

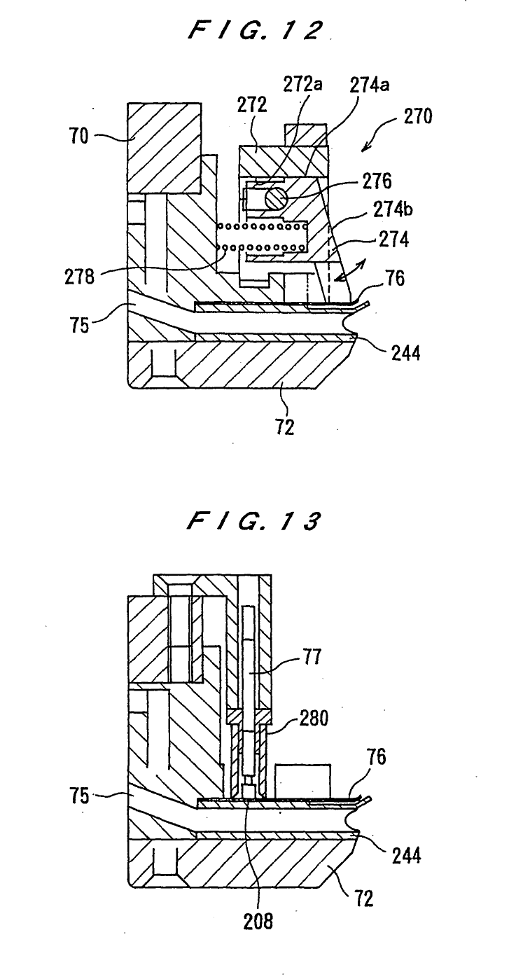

The plating container 50 has first plating solution discharge ports 57 for withdrawing the plating solution 45 contained in the plating chamber 49 from the peripheral portion of the bottom in the plating chamber 49, and second plating solution discharge ports 59 for discharging the plating solution 45 which has overflowed a weir member 58 provided at the upper end of the plating container 50. Further, the plating container 50 has third plating solution discharge ports 120 for discharging the plating solution before overflowing the weir member 58. The plating solution which has flowed through the second plating solution discharge ports 59 and the third plating solution discharge ports 120 joins at the lower end of the plating container 50, and then is discharged from the plating container 50. Instead of providing the third plating solution discharge ports 120, as shown in FIGS. 11A through 11C, the weir member 58 may have, in its lower part, openings 222 having a predetermined width at predetermined intervals so that the plating solution 45 passes through the openings 222 and is then discharged to the second plating solution discharge ports 59.

With this arrangement, when the amount of plating solution supplied is large during plating, the plating solution is discharged to the exterior through the third plating solution discharge ports 120 or is passed through the openings 222 and discharged to the exterior through the second plating solution discharge ports 59 and, in addition, as shown in FIG. 11A, the plating solution overflows the weir member 58 is discharged to the exterior through the second plating solution discharge ports 59. On the other hand, during plating, when the amount of plating solution supplied is small, the plating solution is discharged to the exterior through the third plating solution discharge ports 120, or alternatively as shown in FIG. 11B, the plating solution is passed through the openings 222 and discharged to the exterior through the second plating solution discharge ports 59. In this manner, this construction can easily cope with the case where the amount of plating solution supplied is large or small.

Further, as shown in FIG. 11D, through holes 224 for controlling the liquid level, which are located above the plating solution supply nozzles 53, and communicate with the plating chamber 49 and the second plating solution discharge ports 59, are provided at circumferentially predetermined pitches. Thus, when plating is not performed, the plating solution is passed through the through holes 224, and is discharged to the exterior through the second plating solution discharge ports 59, thereby controlling the liquid level of the plating solution. During plating, the through holes 224 serve as an orifice for restricting the amount of the plating solution flowing therethrough.

As shown in FIG. 6, the first plating solution discharge ports 57 are connected to the reservoir 226 through the plating solution discharge pipe 60a, and a flow controller 61a is provided in the plating solution discharge pipe 60a. The second plating solution discharge ports 59 and the third plating solution discharge ports 120 join with each other within the plating container 50, and the joined passage is then connected directly to the reservoir 226 through the plating solution discharge pipe 60b.

The plating liquid which has flowed into the reservoir 226 is introduced by a pump 228 into the plating liquid regulating tank 40. This plating liquid regulating tank 40 is provided with a temperature controller 230, and a plating liquid analyzing unit 232 for sampling the plating liquid and analyzing the sample liquid. When a pump 234 is operated, the plating liquid is supplied from the plating liquid regulating tank 40 through the filter 236 to the plating solution supply nozzles 53. A control valve 56 is provided in the plating solution supply pipe 55 extending from the plating liquid regulating tank 40 to each of the plating sections 522 to make the pressure on the secondary side constant.

Returning to FIG. 5 a vertical stream regulating ring 62 and a horizontal stream regulating ring 63 are disposed within the plating chamber 49 at a position near the internal circumference of the plating chamber 49, so that the central portion of the liquid surface is pushed up by an upward stream out of two divided upward and downward streams of the plating solution 45 within the plating chamber 49, whereby the downward flow is smoothened and the distribution of the current density is further uniformized. The horizontal stream regulating ring 63 has a peripheral portion which is fixed to the plating container 50, and the vertical stream regulating ring 62 is connected to the horizontal stream regulating ring 63.

On the other hand, the head 47 comprises a housing 70 which is a rotatable and cylindrical receptacle having a downwardly open end and has openings 96 on the circumferential wall, and vertically movable pressing rods 242 having, in its lower end, a pressing ring 240. As shown in FIG. 10, an inwardly projecting ring-shaped substrate holding member 72 is provided at the lower end of the housing 70. A ring-shaped sealing member 244 is mounted on the substrate holding member 72. The ring-shaped sealing member 244 projects inward, and the front end of the top surface in the ring-shaped sealing member 244 projects upward in an annular tapered form. Further, contacts 76 for a cathode electrode are disposed above the sealing member 244. Air vent holes 75, which extend outwardly in the horizontal direction and further extend outwardly in an upwardly inclined state, are provided in the substrate holding member 72 at circumferentially equal intervals.

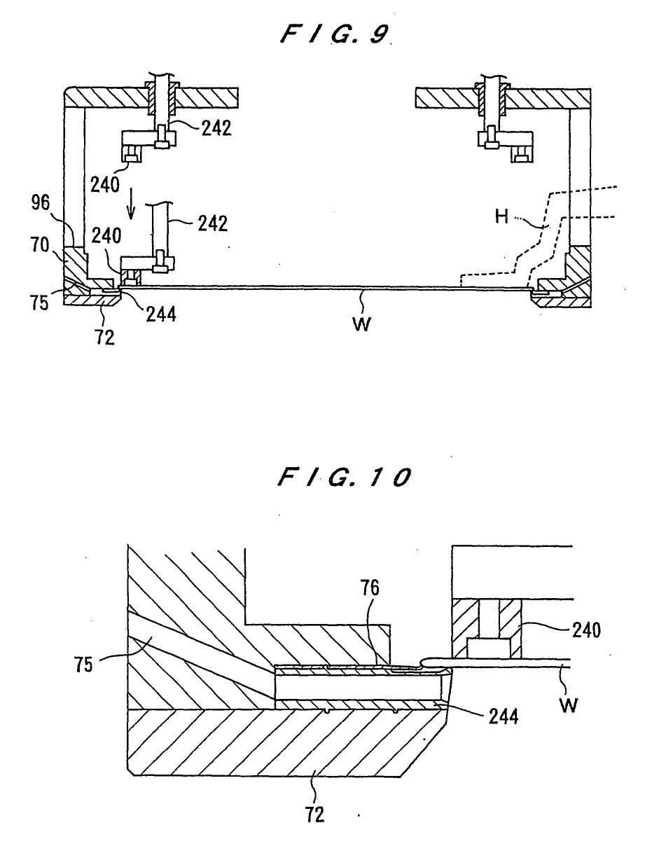

With this arrangement, as shown in FIG. 8, the liquid level of the plating solution 45 in the plating chamber 49 is lowered, and as shown in FIGS. 9 and 10, the substrate W is held by a robot hand H or the like, and inserted into the housing 70 where the substrate W is placed on the upper surface of the sealing member 244 of the substrate holding member 72. Thereafter, the robot hand H is withdrawn from the housing 70, and the pressing ring 240 is then lowered to sandwich the peripheral portion of the substrate W between the sealing member 244 and the lower surface of the pressing ring 240, thereby holding the substrate W. In addition, upon holding of the substrate W, the lower surface of the substrate W is brought into pressure contact with the sealing member 244 to seal this contact portion positively. At the same time, current flows between the substrate W and the contacts 76 for a cathode electrode.

Returning to FIG. 5, the housing 70 is connected to an output shaft 248 of a motor 246, and rotated by energization of the motor 246. The pressing rods 242 are vertically provided at predetermined positions along the circumferential direction of a ring-shaped support frame 258 rotatably mounted through a bearing 256 on the lower end of a slider 254. The slider 254 is vertically movable by actuation of a cylinder 252, with a guide, fixed to a support 250 surrounding the motor 246. With this construction, the pressing rods 242 are vertically movable by the actuation of the cylinder 252, and, in addition, upon the holding of the substrate W, the pressing rods 242 are rotated integrally with the housing 70.

The support 250 is mounted on a slide base 262 which is vertically movable with a rotation of a ball screw 261 rotated by energization of the motor 260. The support 250 is surrounded by an upper housing 264, and is vertically movable together with the upper housing 264 by energization of the motor 260. Further, a lower housing 266 for surrounding the housing 70 during plating is mounted on the upper surface of the plating container 50.

With this construction, as shown in FIG. 8, maintenance can be performed in such a state that the support 250 and the upper housing 264 are raised. A crystal of the plating solution is likely to deposit on the inner circumferential surface of the weir member 58. However, the support 250 and the upper housing 264 are raised, a large amount of the plating solution is flowed and overflows the weir member 58, and hence the crystal of the plating solution is prevented from being deposited on the inner circumferential surface of the weir member 58. A cover 50b for preventing the splash of the plating solution is integrally provided in the plating container 50 to cover a portion above the plating solution which overflows during plating process. By coating an ultra-water-repellent material such as HIREC (manufactured by NTT Advance Technology) on the inner surface of the cover 50b for preventing the splash of the plating solution, the crystal of the plating solution can be prevented from being deposited on the inner surface of the cover 50b.

Substrate centering mechanisms 270 located above the substrate holding member 72 of the housing 70 for performing centering of the substrate W, are provided at four places along the circumferential direction in this embodiment. FIG. 12 shows the substrate centering mechanism 270 in detail. The substrate centering mechanism 270 comprises a gate-like bracket 272 fixed to the housing 70, and a positioning block 274 disposed within the bracket 272. This positioning block 274 is swingably mounted through a support shaft 276 horizontally fixed to the bracket 272. Further, a helical compression spring 278 is interposed between the housing 70 and the positioning block 274. Thus, the positioning block 274 is urged by the helical compression spring 278 so that the positioning block 274 rotates about the support shaft 276 and the lower portion of the positioning block 274 projects inwardly. The upper surface 274a of the positioning block 274 serves as a stopper, and is brought into connect with the lower surface 272a of the bracket 272 to restrict the movement of the positioning block 274. Further, the positioning block 274 has a tapered inner surface 274b which is widened outward in the upward direction.

With this construction, a substrate is held by the hand of a transfer robot or the like, is carried into the housing 70, and is placed on the substrate holding member 72. In this case, when the center of the substrate deviates from the center of the substrate holding member 72, the positioning block 274 is rotated outwardly against the urging force of the helical compression spring 278 and, upon the release of holding of the substrate from the hand of the transfer robot or the like, the positioning block 274 is returned to the original position by the urging force of the helical compression spring 278. Thus, the centering of the substrate can be carried out.

FIG. 13 shows a feeding contact (a probe) 77 for feeding power to a cathode electrode plate 208 having contacts 76 for a cathode electrode. This feeding contact 77 is composed of a plunger and is surrounded by a cylindrical protective member 280 extending to the cathode electrode plate 208, whereby the feeding contact 77 is protected against the plating solution.

The operation of the plating section 522 will now be described.

First, in transferring the substrate W to the plating section 522, the attracting hand of the third transferring device 528 shown in FIG. 1, and the substrate W attracted and held with its front face downward by the attracting hand are inserted into the housing 70 through an opening 96, and the attracting hand is then moved downward. Thereafter, the vacuum attraction is released to place the substrate W on the substrate holding member 72 of the housing 70. The attracting hand is then moved upward and withdrawn from the housing 70. Thereafter, the pressing ring 240 is lowered down to the peripheral portion of the substrate W so as to hold the substrate W between the substrate holding member 72 and the lower surface of the pressing ring 240.

The plating solution 45 is then spurted from the plating supply nozzles 53 while, at the same time, the housing 70 and the substrate W held by the housing 70 are allowed to rotate. When the plating chamber 49 is charged with a predetermined amount of the plating solution 45, and further after an elapse of several seconds, the rotational speed of the housing 70 is decreased to a slow rotation (e.g. 100 min⁻¹). Then, electroplating is carried out by passing an electric current between the anode 48 and the surface, to be plated, of the substrate W as a cathode.

After the supply of the electric current, as shown in FIG. 11D, the feed of the plating solution is decreased so that the liquid is allowed to flow out only through the through holes 224 for liquid level control positioned above the plating solution injection nozzle 53, thereby exposing the housing 70, together with the substrate W held by the housing 70, above the surface of the plating solution. The housing 70 and the substrate W, positioned above the liquid surface, are allowed to rotate at a high speed (e.g. 500-800 min⁻¹) to drain away the plating solution by the action of centrifugal force. After the completion of draining, the rotation of the housing 70 is stopped so that the housing 70 stops at a predetermined position.

After the housing 70 comes to a complete stop, the pressing ring 240 is moved upward. Thereafter, the attracting hand of the third transferring device 528 is inserted, with its attracting face downward, into the housing 70 through the opening 96 and is then lowered to a position at which the attracting hand can attract the substrate. After attracting the substrate by vacuum attraction, the attracting hand is moved upward to the position of the opening 96 of the housing 70, and is withdrawn, together with the substrate held by the attracting hand, through the opening 96.

According to the plating section 522, the head 47 can be designed to be compact and structurally simple. Further, the plating can be carried out when the surface of the plating solution in the plating process container 46 lies at the plating level, and the draining and the transferring of the substrate can be carried out when the surface of the plating solution lies at the substrate-transferring level. Moreover, the black film formed on the surface of the anode 48 can be prevented from being dried and oxidized.

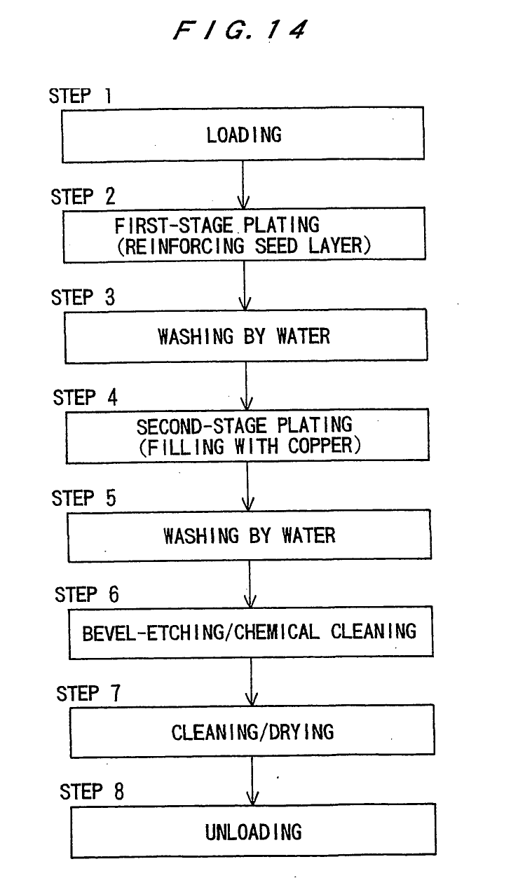

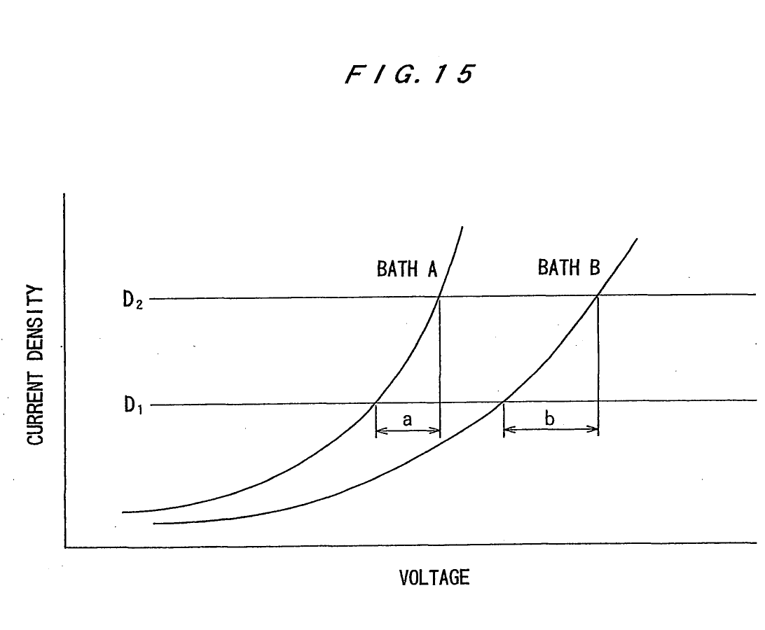

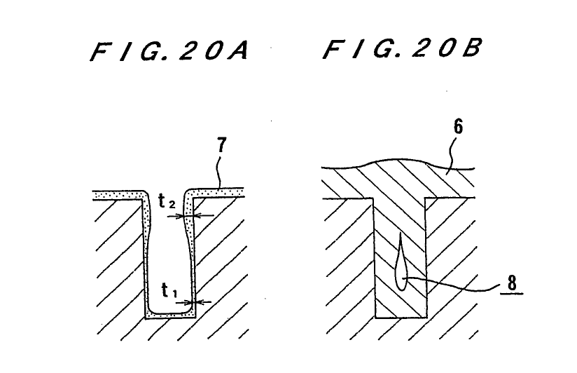

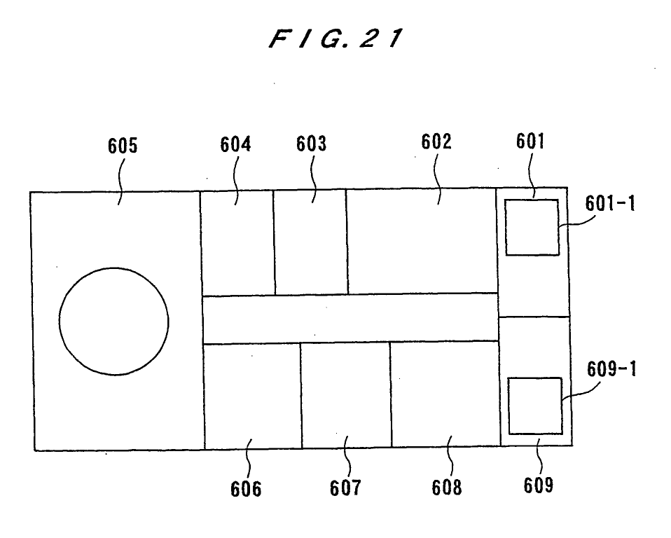

A plating method of the present invention will now be described by referring to FIG. 14. According to this embodiment, of the four plating sections 522 as shown in FIG. 1, one is employed as a first plating section 522a for first-stage plating and the other three are employed as second plating sections 22b for second-stage plating. The first-stage plating in the first plating section 522a is to reinforce the thin portion of the seed layer 7 as shown in FIG. 20A so as to obtain a uniform thickness of seed layer 7, and the second-stage plating in the second plating section 522b is to deposit copper onto the reinforced seed layer so as to fill trenches with copper.

In the first plating section 522a, a plating solution (first plating liquid) is used, as the plating solution 45 (see FIG. 5), which contains monovalent or divalent copper ions, a complexing agent, and an organic sulfur compound as an additive, and may further contain, according to necessity, additives such as a surfactant and a pH adjusting agent, and which has an excellent uniform electrodeposition property.

The monovalent or divalent copper ions can be supplied from copper sulfate, copper acetate, copper chloride, copper pyrophosphate, EDTA-copper, copper nitrate, copper sulfamate, copper carbonate, copper oxide, copper cyanide, etc.

Specific examples of the complexing agent may include ethylenediamine tetracetic acid, ethylenediamine, N,N′,N″,N′″-ethylene-di-nitro-tetrapropane-2-ol, pyrophosphoric acid, iminodiacetic acid, diethylenetriamine, triethylenetetramine, tetraethylenepentamine, diamino butane, hydroxyethyl ethylenediamine, ethylediamine tetrapropionic acid, ethylenediamine tetramethylene phosphonic acid, diethylenetriamine tetramethylene phosphonic acid and their derivatives, and their salts.

Specific examples of the organic sulfur compound for use as an additive in the copper-plating solution may include the below-described organic sulfide sulfonic acid compounds (organic sulfide compounds) (1)-(24) of Group I, the below-described organic sulfur compounds (organic sulfide compounds) (1)-(9) of Group II, and the below-described organic polysulfide compounds (1)-(7) of Group III.

These compounds may be used singly or as a mixture of two or more.

Group I

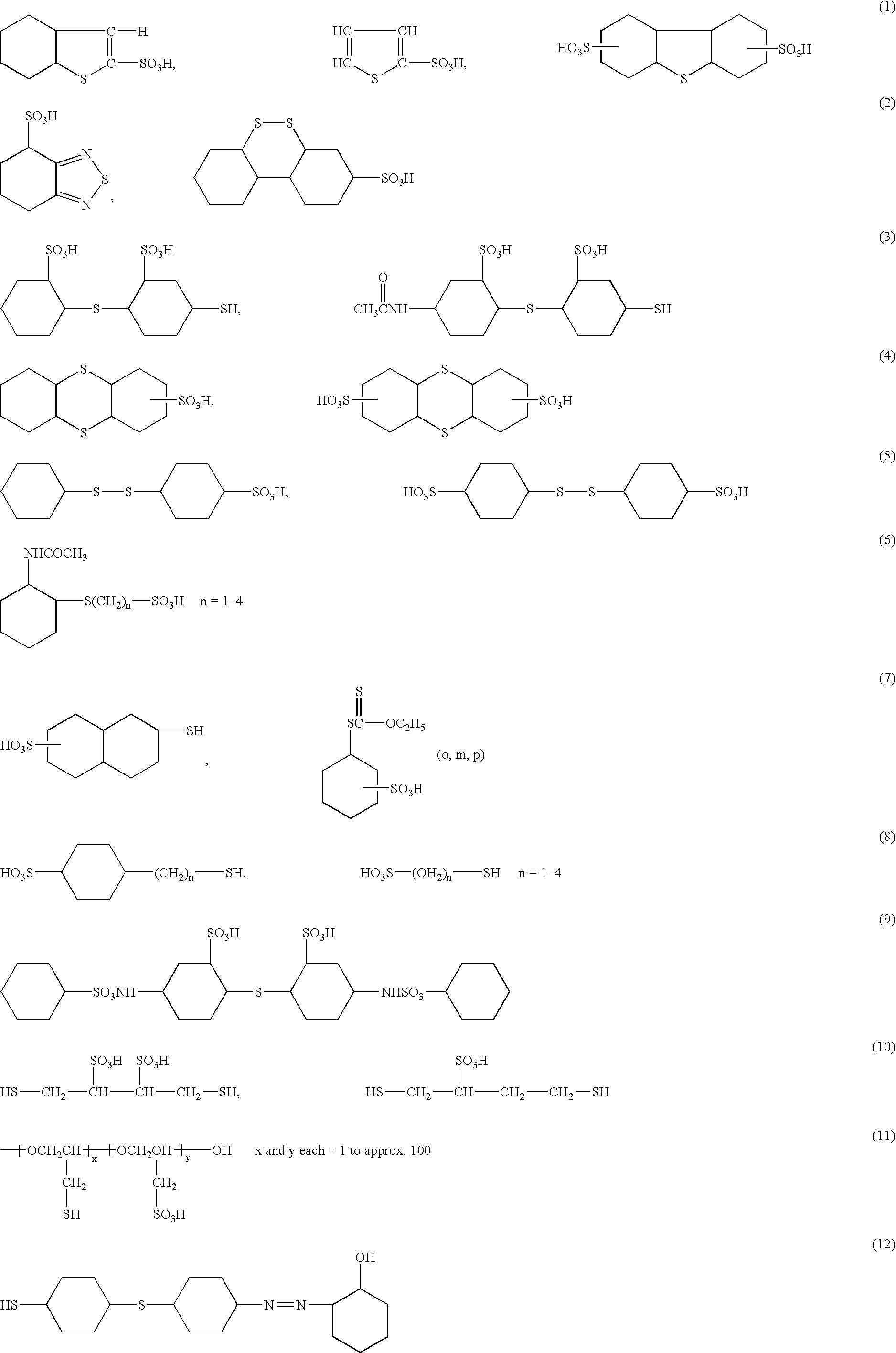

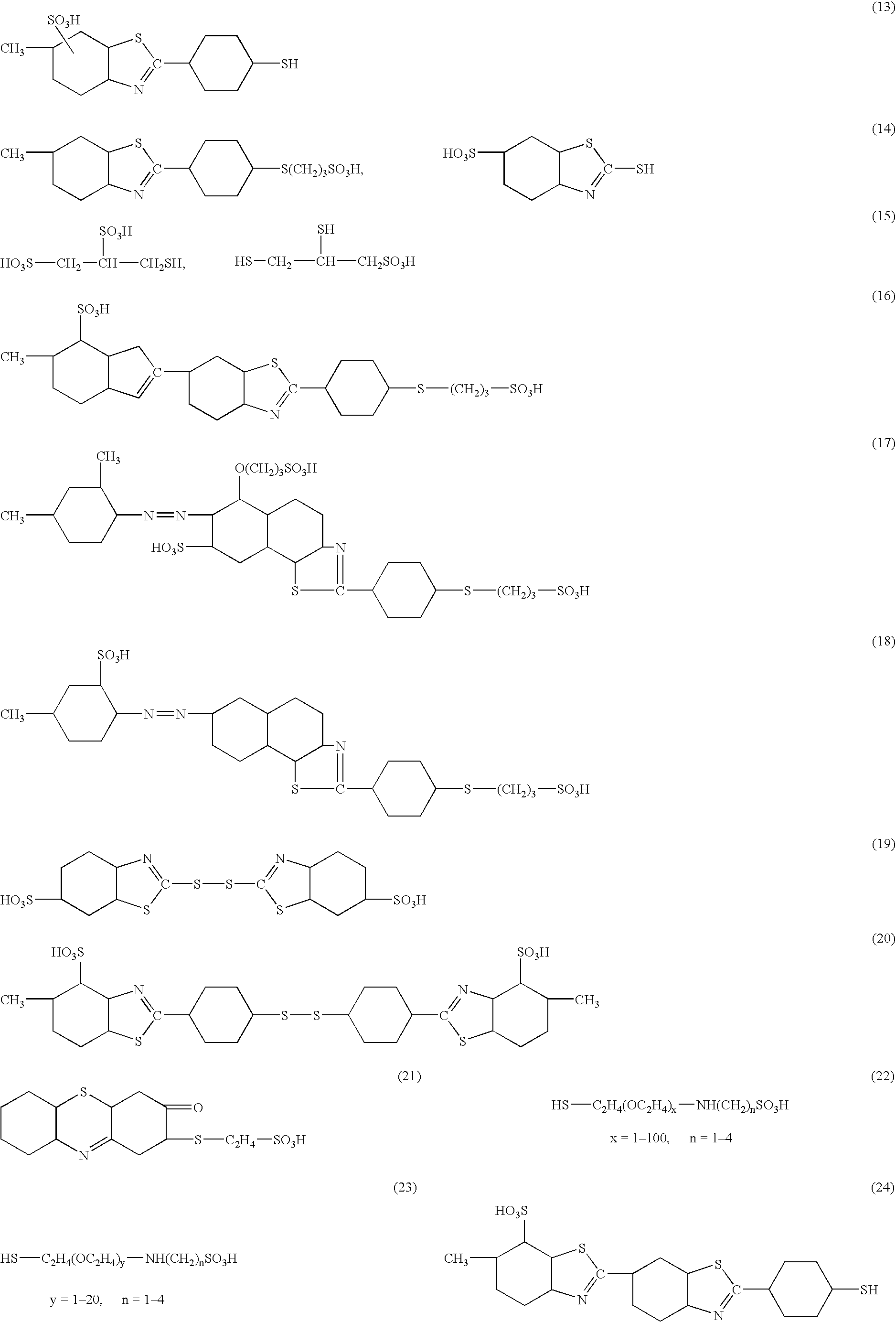

Group II

(1) N,N-diethyldithiocarbamic acid-(ω-sulfopropyl)-ester, sodium salt

(2) Mercaptobenzothiazol-S-propanesulfonic acid, sodium salt

(3) 3-mercaptopropane-1-sulfonic acid, sodium salt

(4) Thiophosphoric acid-O-ethyl-bis(ω-sulfopropyl)-ester, disodium salt

(5) Thiophosphoric acid-tris (ω-sulfopropyl)-ester, trisodium salt

(6) Isothiocyanopropylsulfonic acid, sodium salt

(7) Thioglycolic acid

(8) Ethylenedithiodipropylsulfonic acid, sodium salt

(9) Thioacetamide-S-propylsulfonic acid, sodium salt

Group III

(1) CH₃—S—S—CH₂—SO₃H

(2) CH₃—S—S—S—(CH₂)₄—SO₃H

(3) HO₃S—CH₂—S—S—S—S—S—CH₂—SO₃H

(4) HO₃S—(CH₂)₃—S—S—(CH₂)₃—SO₃H

(5) (CH₃)₂CHCH₂—S—S—CH₂CH(CH₃)₂

(6) (CH₃)₃C—S—S—C(CH₂)₂ SO₃H

(7) HO₃S—(CH₂)₄—S—S—(CH₂)₄—SO₃H

The surfactant is added to the first plating solution in order to improve the wetting property so that the plating solution can more easily enter into a small hole, and to restrain the deposition of copper on the surface of a substrate to thereby enhance the copper-embedding property. Polyalkylene glycols, their EO (ethylene oxide) or PO (propylene oxide) adducts, i.e. polyether polyols, quaternary ammonium salts, etc. may be used as the surfactant.

The first plating solution is adjusted at a pH of 7-14, preferably at a pH of 8-10, more preferably at a pH of about 9 by the addition of the pH adjusting agent. When the pH of the plating solution is too low, the complexing agent cannot effectively combine with copper, thus failing to provide a complete complex. On the other hand, too high a pH of the plating solution can bring about the formation of a variant form of complex which makes a sediment. The above-described pH range can obviate these drawbacks. Choline, sulfuric acid, hydrochloric acid, phosphoric acid, ammonia, TMAH (tetramethyl ammonium hydroxide), etc. may be used as the pH adjusting agent.

In the second plating section 522b, a copper sulfate plating solution (second plating, liquid) containing copper sulfate and sulfuric acid, and having an excellent leveling property is used as the plating solution 45 (see FIG. 5).

First, the substrate W having a seed layer 7 (see FIG. 19A) as an electric supply layer is taken one by one from the loading/unloading section 510 by the first transferring device 524, and is transferred, via the first substrate stage 514 and the second substrate stage 518, to the first plating section 522a (step 1).

Next, the first-stage plating is carried out in the first plating section 522a, using the first plating solution, thereby reinforcing and completing the thin portion of the seed layer 7 (step 2). The first plating solution used in the first plating section 522a, e.g. a plating solution comprising copper pyrophosphate as a base, and a complexing agent such as pyrophosphoric acid, has a higher polarization than a usual copper sulfate plating solution (second plating liquid). “High polarization” herein means that the ratio of the degree of change in voltage to the degree of change in current density is high, that is, the degree of change in current density is relative to a fluctuation of potential is low. Referring to the cathode polarization curves shown in FIG. 15, for example, the ratio b/(D₂- D₁) for the plating bath B is higher than the ratio a/(D₂- D₁) for the plating bath A, indicating that the plating bath B has a higher polarization than the plating bath A. Thus, the plating solution having a high polarization such as the plating bath B, when used in the plating of the substrate having a seed layer 7 in which a difference in film thickness exists, which produces a potential difference upon supply of electric current, can make the change in current density small. This makes it possible to raise the deposition potential and improve uniform electrodeposition property, whereby it becomes possible to deposit a plated film even on the thin portion of the seed layer, which has been difficult with a usual copper sulfate plating solution.

Further, the use of the organic sulfur compound as an additive in the first plating solution makes it possible to carry out plating even onto a thinner underlying conductive layer (seed layer) (e.g. having a thickness, on the surface of a substrate, of 100 nm or less) than one with which plating has hitherto been possible. In addition, the first plating solution, due to the use of the additive, is excellent in the so-called bottom-up property and can be deposited copper from the bottom of the fine recesses so as to decrease aspect ratio of the fine recesses, making it possible to fill with copper fine trenches or holes having such a high or severe aspect ratio that filling with copper has never been possible in the next filling process. It is considered in this regard that the organic sulfur component may restrain a copper chelate from taking off the chelate (ligand) and depositing on the surface of a substrate, whereby a larger amount of copper can be deposited in the depth of such fine trenches or holes. The organic sulfur compound additive, due to its polarity, can be easily determined of its concentration by using an electrochemical measuring method, such as CVS method which is generally employed for measuring the concentration of an additive in a copper-plating solution. In addition, since the organic sulfur compound additive is very stable in the plating solution, the liquid management can be made with ease. The concentration of the organic sulfur compound additive is generally in the range of 0.1-500 mg/l, preferably 0.5-100 mg/l, more preferably 1-50 mg/l.

Furthermore, the use of the surfactant, which may be added to the first plating solution according to necessity, can improve the wetting property of the plating solution so that the plating solution can more easily enter into a small hole and, in addition, can further restrain the deposition of copper on the surface of the substrate to thereby further enhance the copper-embedding property.

When a complex and a surfactant free from an alkali metal are used, deterioration of the semiconductor properties due to inclusion of an alkali metal in the film can be avoided.

Direct current, pulse, PR pulse, etc. may be employed as a power source. Of these, pulse and PR pulse are preferred. The use of such a power source can improve the diffusion of copper ions to thereby further improve the uniform electrodeposition property, can flow a larger electric current than direct current to thereby make the deposited copper film denser, and can shorten the plating time.

When a direct current power source is employed, an applicable current density is in the range of 0.01 A/dm²-30 A/dm², preferably 0.1 A/dm² 3 A/dm². In the case of a pulse power source, a current density of 0.01 A/dm²-200 A/dm² is applicable. The above ranges of current density can prevent the lowering of productivity, and can prevent the occurrence of “burnt deposit”. The temperature of the first plating solution may be in the range of 10° C.-80° C., preferably about 25° C.

After the completion of the first-stage plating, the substrate W is, according to necessity, transferred to the washing section 520 for washing by water (step 3), and is then transferred to one of the second plating sections 522b.

Next, the second-stage plating is performed onto the surface of the substrate W in the second plating section 522b, using a copper sulfate plating solution (second plating liquid) having an excellent leveling property, which has a composition of a high copper sulfate concentrate and a low sulfuric acid concentration, e.g. a composition of 100-300 g/l of copper sulfate and 10-100 g/l of sulfuric acid, and which further contains an additive for enhancing the leveling property, thereby effecting filling with copper (step 4). Since the seed layer 7 (see FIG. 19A) has been reinforced by the first-stage plating to become a complete layer without a thin portion, electric current flows evenly through the seed layer 7 in the second-stage plating, whereby the filling with copper can be completed without the formation of any voids.

The “leveling property” herein refers to a property of giving a flat plating surface. The use of the plating solution having an excellent leveling property can retard the growth of plating at the inlet of a fine recess. This makes it possible to fully fill the fine recesses with copper uniformly without formation of any void, and further flatten the plating surface.

After the completion of the second-stage plating, the substrate W is, according to necessity, transferred to the washing section 520 for washing by water (step 5). Thereafter, the substrate W is transferred to the bevel-etching/chemical cleaning section 516 where the substrate W is cleaned by using a chemical liquid, and a thin copper film, etc. formed on the bevel portion of the substrate W is etched away (step 6). The substrate is then transferred to the cleaning/drying section 512 for cleaning and drying (step 7). Thereafter, the substrate is returned to the cassette of the loading/unloading section 510 by the first transferring device 524 (step 8).

A process of annealing a substrate W may be performed between the Step 7 and the Step 8. When a substrate W is annealed at 200-500° C., preferably about 400° C., the electric characteristics of copper film formed on the substrate W can be improved. For example, if the bevel-etching/chemical cleaning section 516 has a supplementary function of a cleaning and drying unit, then an annealing section (annealing unit) may be provided instead of the cleaning/drying section 512.

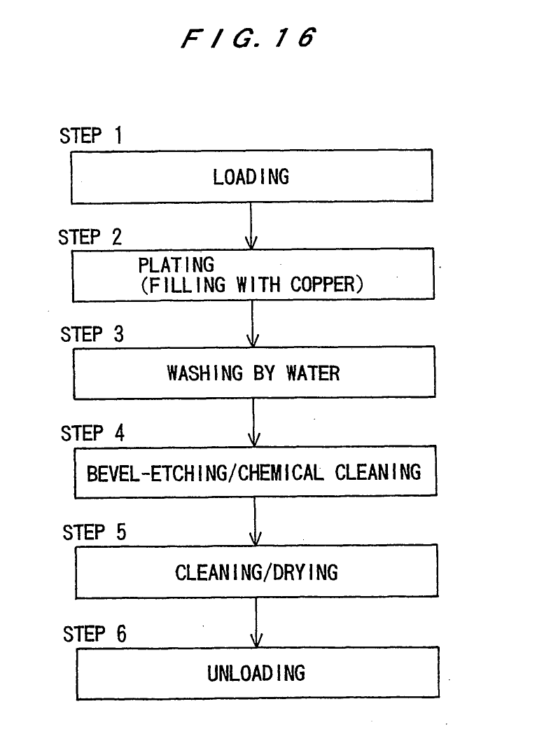

Another embodiment of the plating method of the present invention will be described below, by referring to FIG. 16. According to this embodiment, all of the four plating sections 522 shown in FIG. 1 are used for filling with copper. The reinforcement of the thin portion of a seed layer, carried out in the described above embodiment, is not carried out in this embodiment. In the plating section 522, a plating solution, which is the same as the above-described first plating solution, is used as the copper-plating solution 45 (see FIG. 5), which contains monovalent or divalent copper ions, a complexing agent, and an organic sulfur compound as an additive, and may further contain, according to necessity, additives such as a surfactant and a pH adjusting agent, and which has an excellent uniform electrodeposition property.

First, the substrate W having a seed layer 7 (see FIG. 19A) as an electric supply layer is taken one by one from the loading/unloading section 510 by the first transferring device 524, and is transferred, via the first substrate stage 514 and the second substrate stage 518, to one of the plating sections 522 (step 1).

Next, plating is performed in the plating section 522 using the above first plating solution, thereby effecting filling with copper (step 2). The plating solution used in this plating has the same high polarization as the first plating solution to be used in the first plating section 522a according to the first embodiment of the present invention. Due to the high polarization, the plating solution can raise the deposition potential and improve uniform electrodeposition property, whereby it becomes possible to deposit copper even on the thin portion of the seed layer, which has been difficult with a usual copper sulfate plating solution. Further, the plating solution can grow the plating so as to effect complete filling with copper of the fine recesses in the substrate without formation of any void. The plating conditions are substantially the same as in the first-stage plating according to the first embodiment of the present invention.

After the completion of plating, the substrate W is, according to necessity, transferred to the washing section 520 for washing by water (step 3). Thereafter, the substrate W is transferred to the bevel-etching/chemical cleaning section 516 where the substrate W is cleaned by using a chemical liquid, and a thin copper film, etc. formed on the bevel portion of the substrate W is etched away (step 4). The substrate is then transferred to the cleaning/drying section 512 for cleaning and drying (step 5). Thereafter, the substrate W is returned to the cassette of the loading/unloading section 510 by the first transferring device 524 (step 6).

Annealing process may be carried out between cleaning and drying process (step 5) and unloading process (step 6) shown in FIG. 14.

FIG. 21 is a plan view of another example of a substrate plating apparatus. The substrate plating apparatus shown in FIG. 21 comprises a loading unit 601 for loading a semiconductor substrate, a copper plating chamber 602 for plating a semiconductor substrate with copper, a pair of water cleaning chambers 603, 604 for cleaning a semiconductor substrate with water, a chemical mechanical polishing unit 605 for chemically and mechanically polishing a semiconductor substrate, a pair of water cleaning chambers 606, 607 for cleaning a semiconductor substrate with water, a drying chamber 608 for drying a semiconductor substrate, and an unloading unit 609 for unloading a semiconductor substrate with an interconnection film thereon. The substrate plating apparatus also has a substrate transfer mechanism (not shown) for transferring semiconductor substrates to the chambers 602, 603, 604, the chemical mechanical polishing unit 605, the chambers 606, 607, 608, and the unloading unit 609. The loading unit 601, the chambers 602, 603, 604, the chemical mechanical polishing unit 605, the chambers 606, 607, 608, and the unloading unit 609 are combined into a single unitary arrangement as apparatus.

The substrate plating apparatus operates as follows: The substrate transfer mechanism transfers a semiconductor substrate W on which an interconnection film has not yet been formed from a substrate cassette 601-1 placed in the loading unit 601 to the copper plating chamber 602. In the copper plating chamber 602, a plated copper film is formed on a surface of the semiconductor substrate W having an interconnection region composed of an interconnection trench and an interconnection hole (contact hole).

After the plated copper film is formed on the semiconductor substrate W in the copper plating chamber 602, the semiconductor substrate W is transferred to one of the water cleaning chambers 603, 604 by the substrate transfer mechanism and cleaned by water in one of the water cleaning chambers 603, 604. The cleaned semiconductor substrate W is transferred to the chemical mechanical polishing unit 605 by the substrate transfer mechanism. The chemical mechanical polishing unit 605 removes the unwanted plated copper film from the surface of the semiconductor substrate W, leaving a portion of the plated copper film in the interconnection trench and the interconnection hole. A barrier layer made of TiN or the like is formed on the surface of the semiconductor substrate W, including the inner surfaces of the interconnection trench and the interconnection hole, before the plated copper film is deposited.

Then, the semiconductor substrate W with the remaining plated copper film is transferred to one of the water cleaning chambers 606, 607 by the substrate transfer mechanism and cleaned by water in one of the water cleaning chambers 607, 608. The cleaned semiconductor substrate W is then dried in the drying chamber 608, after which the dried semiconductor substrate W with the remaining plated copper film serving as an interconnection film is placed into a substrate cassette 609-1 in the unloading unit 609.

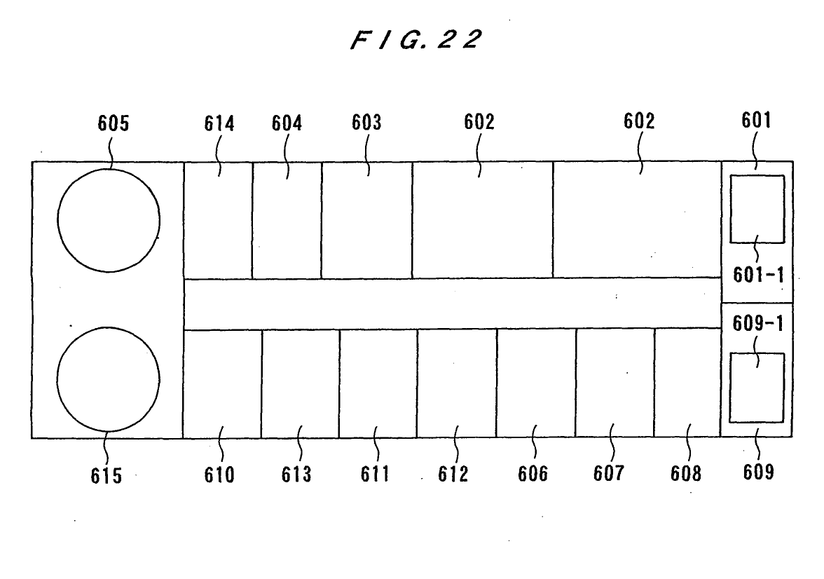

FIG. 22 shows a plan view of still another example of a substrate plating apparatus. The substrate plating apparatus shown in FIG. 22 differs from the substrate plating apparatus shown in FIG. 21 in that it additionally includes a copper plating chamber 602, a water cleaning chamber 610, a pretreatment chamber 611, a protective layer plating chamber 612 for forming a protective plated layer on a plated copper film on a semiconductor substrate, water cleaning chamber 613, 614, and a chemical mechanical polishing unit 615. The loading unit 601, the chambers 602, 602, 603, 604, 614, the chemical mechanical polishing unit 605, 615, the chambers 606, 607, 608, 610, 611, 612, 613, and the unloading unit 609 are combined into a single unitary arrangement as an apparatus.

The substrate plating apparatus shown in FIG. 22 operates as follows: A semiconductor substrate W is supplied from the substrate cassette 601-1 placed in the loading unit 601 successively to one of the copper plating chambers 602, 602. In one of the copper plating chamber 602, 602, a plated copper film is formed on a surface of a semiconductor substrate W having an interconnection region composed of an interconnection trench and an interconnection hole (contact hole). The two copper plating chambers 602, 602 are employed to allow the semiconductor substrate W to be plated with a copper film for a long period of time. Specifically, the semiconductor substrate W may be plated with a primary copper film according to electroless-plating in one of the copper plating chamber 602, and then plated with a secondary copper film according to electroplating in the other copper plating chamber 602. The substrate plating apparatus may have more than two copper plating chambers.

The semiconductor substrate W with the plated copper film formed thereon is cleaned by water in one of the water cleaning chambers 603, 604. Then, the chemical mechanical polishing unit 605 removes the unwanted portion of the plated copper film from the surface of the semiconductor substrate W, leaving a portion of the plated copper film in the interconnection trench and the interconnection hole.

Thereafter, the semiconductor substrate W with the remaining plated copper film is transferred to the water cleaning chamber 610, in which the semiconductor substrate W is cleaned with water. Then, the semiconductor substrate W is transferred to the pretreatment chamber 611, and pretreated therein for the deposition of a protective plated layer. The pretreated semiconductor substrate W is transferred to the protective layer plating chamber 612. In the protective layer plating chamber 612, a protective plated layer is formed on the plated copper film in the interconnection region on the semiconductor substrate W. For example, the protective plated layer is formed with an alloy of nickel (Ni) and boron (B) by electroless-plating.

After semiconductor substrate is cleaned in one of the water cleaning chamber 613, 614, an upper portion of the protective plated layer deposited on the plated copper film is polished off to planarize the protective plated layer, in the chemical mechanical polishing unit 615,

After the protective plated layer is polished, the semiconductor substrate W is cleaned by water in one of the water cleaning chambers 606, 607, dried in the drying chamber 608, and then transferred to the substrate cassette 609-1 in the unloading unit 609.

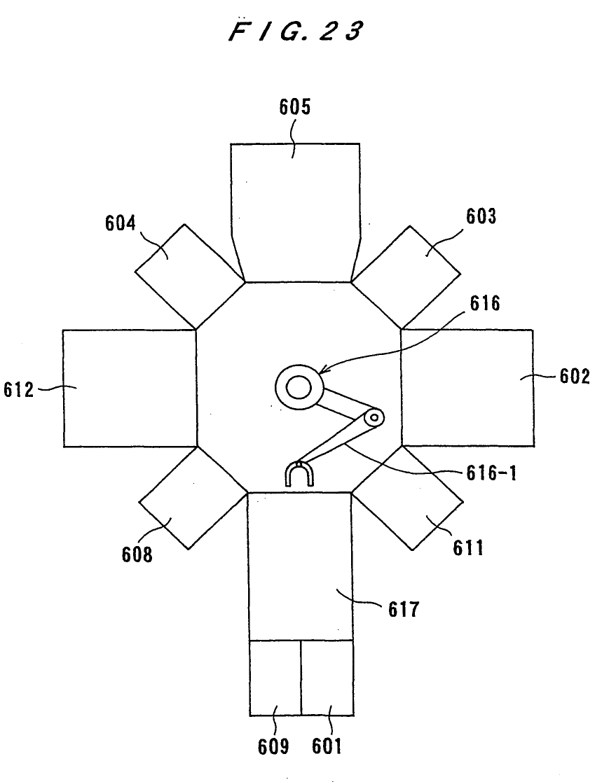

FIG. 23 is a plan view of still another example of a substrate plating apparatus. As shown in FIG. 23, the substrate plating apparatus includes a robot 616 at its center which has a robot arm 616-1, and also has a copper plating chamber 602, a pair of water cleaning chambers 603, 604, a chemical mechanical polishing unit 605, a pretreatment chamber 611, a protective layer plating chamber 612, a drying chamber 608, and a loading/unloading station 617 which are disposed around the robot 616 and positioned within the reach of the robot arm 616-1. A loading unit 601 for loading semiconductor substrates and an unloading unit 609 for unloading semiconductor substrates is disposed adjacent to the loading/unloading station 617. The robot 616, the chambers 602, 603, 604, the chemical mechanical polishing unit 605, the chambers 608, 611, 612, the loading/unloading station 617, the loading unit 601, and the unloading unit 609 are combined into a single unitary arrangement as an apparatus.

The substrate plating apparatus shown in FIG. 23 operates as follows:

A semiconductor substrate to be plated is transferred from the loading unit 601 to the loading/unloading station 617, from which the semiconductor substrate is received by the robot arm 616-1 and transferred thereby to the copper plating chamber 602. In the copper plating chamber 602, a plated copper film is formed on a surface of the semiconductor substrate which has an interconnection region composed of an interconnection trench and an interconnection hole. The semiconductor substrate with the plated copper film formed thereon is transferred by the robot arm 616-1 to the chemical mechanical polishing unit 605. In the chemical mechanical polishing unit 605, the plated copper film is removed from the surface of the semiconductor substrate W, leaving a portion of the plated copper film in the interconnection trench and the interconnection hole.

The semiconductor substrate is then transferred by the robot arm 616-1 to the water cleaning chamber 604, in which the semiconductor substrate is cleaned by water. Thereafter, the semiconductor substrate is transferred by the robot arm 616-1 to the pretreatment chamber 611, in which the semiconductor substrate is pretreated therein for the deposition of a protective plated layer. The pretreated semiconductor substrate is transferred by the robot arm 616-1 to the protective layer plating chamber 612. In the protective layer plating chamber 612, a protective plated layer is formed on the plated copper film in the interconnection region on the semiconductor substrate W. The semiconductor substrate with the protective plated layer formed thereon is transferred by the robot arm 616-1 to the water cleaning chamber 604, in which the semiconductor substrate is cleaned by water. The cleaned semiconductor substrate is transferred by the robot arm 616-1 to the drying chamber 608, in which the semiconductor substrate is dried. The dried semiconductor substrate is transferred by the robot arm 616-1 to the loading/unloading station 617, from which the plated semiconductor substrate is transferred to the unloading unit 609.

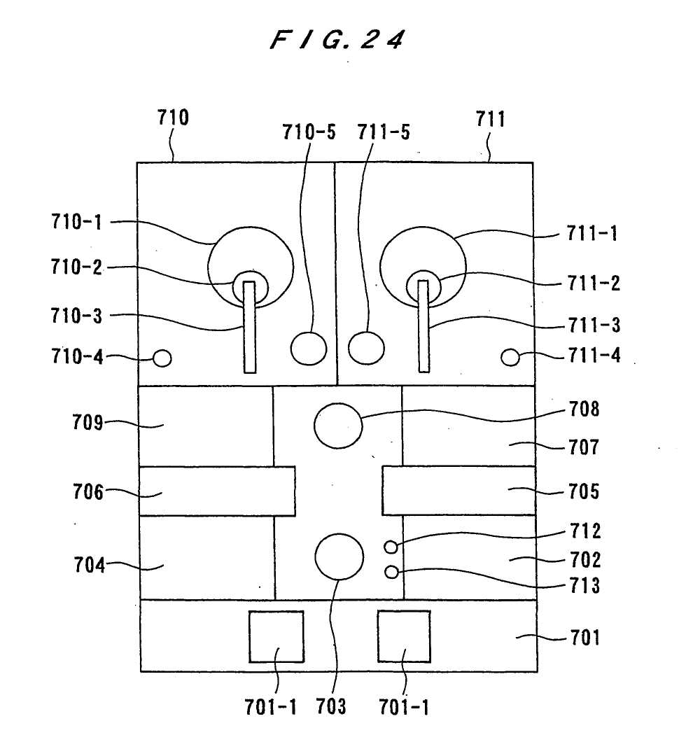

FIG. 24 is a view showing the plan constitution of another example of a semiconductor substrate processing apparatus. The semiconductor substrate processing apparatus is of a constitution in which there are provided a loading/unloading section 701, a plated Cu film forming unit 702, a first robot 703, a third cleaning machine 704, a reversing machine 705, a reversing machine 706, a second cleaning machine 707, a second robot 708, a first cleaning machine 709, a first polishing apparatus 710, and a second polishing apparatus 711. A before-plating and after-plating film thickness measuring instrument 712 for measuring the film thicknesses before and after plating, and a dry state film thickness measuring instrument 713 for measuring the film thickness of a semiconductor substrate W in a dry state after polishing are placed near the first robot 703.

The first polishing apparatus (polishing unit) 710 has a polishing table 710-1, a top ring 710-2, a top ring head 710-3, a film thickness measuring instrument 710-4, and a pusher 710-5. The second polishing apparatus (polishing unit) 711 has a polishing table 711-1, a top ring 711-2, a top ring head 711-3, a film thickness measuring instrument 711-4, and a pusher 711-5.

A cassette 701-1 accommodating the semiconductor substrates W, in which a via hole and a trench for interconnect are formed, and a seed layer is formed thereon is placed on a loading port of the loading/unloading section 701. The first robot 703 takes out the semiconductor substrate W from the cassette 701-1, and carries the semiconductor substrate W into the plated Cu film forming unit 702 where a plated Cu film is formed. At this time, the film thickness of the seed layer is measured with the before-plating and after-plating film thickness measuring instrument 712. The plated Cu film is formed by carrying out hydrophilic treatment of the face of the semiconductor substrate W, and then Cu plating. After formation of the plated Cu film, rinsing or cleaning of the semiconductor substrate W is carried out in the plated Cu film forming unit 702.

When the semiconductor substrate W is taken out from the plated Cu film forming unit 702 by the first robot 703, the film thickness of the plated Cu film is measured with the before-plating and after-plating film thickness measuring instrument 712. The results of its measurement are recorded into a recording device (not shown) as record data on the semiconductor substrate, and are used for judgment of an abnormality of the plated Cu film forming unit 702. After measurement of the film thickness, the first robot 703 transfers the semiconductor substrate W to the reversing machine 705, and the reversing machine 705 reverses the semiconductor substrate W (the surface on which the plated Cu film has been formed faces downward). The first polishing apparatus 710 and the second polishing apparatus 711 perform polishing in a serial mode and a parallel mode. Next, polishing in the serial mode will be described.

In the serial mode polishing, a primary polishing is performed by the polishing apparatus 710, and a secondary polishing is performed by the polishing apparatus 711. The second robot 708 picks up the semiconductor substrate W on the reversing machine 705, and places the semiconductor substrate W on the pusher 710-5 of the polishing apparatus 710. The top ring 710-2 attracts the semiconductor substrate W on the pusher 710-5 by suction, and brings the surface of the plated Cu film of the semiconductor substrate W into contact with a polishing surface of the polishing table 710-1 under pressure to perform a primary polishing. With the primary polishing, the plated Cu film is basically polished. The polishing surface of the polishing table 710-1 is composed of foamed polyurethane such as IC1000, or a material having abrasive grains fixed thereto or impregnated therein. Upon relative movements of the polishing surface and the semiconductor substrate W, the plated Cu film is polished.

After completion of polishing of the plated Cu film, the semiconductor substrate W is returned onto the pusher 710-5 by the top ring 710-2. The second robot 708 picks up the semiconductor substrate W, and introduces it into the first cleaning machine 709. At this time, a chemical liquid may be ejected toward the face and backside of the semiconductor substrate W on the pusher 710-5 to remove particles therefrom or cause particles to be difficult to adhere thereto.

After completion of cleaning in the first cleaning machine 709, the second robot 708 picks up the semiconductor substrate W, and places the semiconductor substrate W on the pusher 711-5 of the second polishing apparatus 711. The top ring 711-2 attracts the semiconductor substrate W on the pusher 711-5 by suction, and brings the surface of the semiconductor substrate W, which has the barrier layer formed thereon, into contact with a polishing surface of the polishing table 711-1 under pressure to perform the secondary polishing. The constitution of the polishing table is the same as the top ring 711-2. With this secondary polishing, the barrier layer is polished. However, there may be a case in which a Cu film and an oxide film left after the primary polishing are also polished.

A polishing surface of the polishing table 711-1 is composed of foamed polyurethane such as IC1000, or a material having abrasive grains fixed thereto or impregnated therein. Upon relative movements of the polishing surface and the semiconductor substrate W, polishing is carried out. At this time, silica, alumina, ceria, on the like is used as abrasive grains or slurry. A chemical liquid is adjusted depending on the type of the film to be polished.

Detection of an end point of the secondary polishing is performed by measuring the film thickness of the barrier layer mainly with the use of the optical film thickness measuring instrument, and detecting the film thickness which has become zero, or the surface of an insulating film comprising SiO₂ shows up. Furthermore, a film thickness measuring instrument with an image processing function is used as the film thickness measuring instrument 711-4 provided near the polishing table 711-1. By use of this measuring instrument, measurement of the oxide film is made, the results are stored as processing records of the semiconductor substrate W, and used for judging whether the semiconductor substrate W in which secondary polishing has been finished can be transferred to a subsequent step or not. If the end point of the secondary polishing is not reached, re-polishing is performed. If over-polishing has been performed beyond a prescribed value due to any abnormality, then the semiconductor substrate processing apparatus is stopped to avoid next polishing so that defective products will not increase.

After completion of the secondary polishing, the semiconductor substrate W is moved to the pusher 711-5 by the top ring 711-2. The second robot 708 picks up the semiconductor substrate W on the pusher 711-5. At this time, a chemical liquid may be ejected toward the face and backside of the semiconductor substrate W on the pusher 711-5 to remove particles therefrom or cause particles to be difficult to adhere thereto.

The second robot 708 carries the semiconductor substrate W into the second cleaning machine 707 where cleaning of the semiconductor substrate W is performed. The constitution of the second cleaning machine 707 is also the same as the constitution of the first cleaning machine 709. The face of the semiconductor substrate W is scrubbed with the PVA sponge rolls using a cleaning liquid comprising pure water to which a surface active agent, a chelating agent, or a pH adjusting agent is added. A strong chemical liquid such as DHF is ejected from a nozzle toward the backside of the semiconductor substrate W to perform etching of the diffused Cu thereon. If there is no problem of diffusion, scrubbing cleaning is performed with the PVA sponge rolls using the same chemical liquid as that used for the face.

After completion of the above cleaning, the second robot 708 picks up the semiconductor substrate W and transfers it to the reversing machine 706, and the reversing machine 706 reverses the semiconductor substrate W. The semiconductor substrate W which has been reversed is picked up by the first robot 703, and transferred to the third cleaning machine 704. In the third cleaning machine 704, megasonic water excited by ultrasonic vibrations is ejected toward the face of the semiconductor substrate W to clean the semiconductor substrate W. At this time, the face of the semiconductor substrate W may be cleaned with a known pencil type sponge using a cleaning liquid comprising pure water to which a surface active agent, a chelating agent, or a pH adjusting agent is added. Thereafter, the semiconductor substrate W is dried by spin-drying.

As described above, if the film thickness has been measured with the film thickness measuring instrument 711-4 provided near the polishing table 711-1, then the semiconductor substrate W is not subjected to further process and is accommodated into the cassette placed on the unloading port of the loading/unloading section 771.

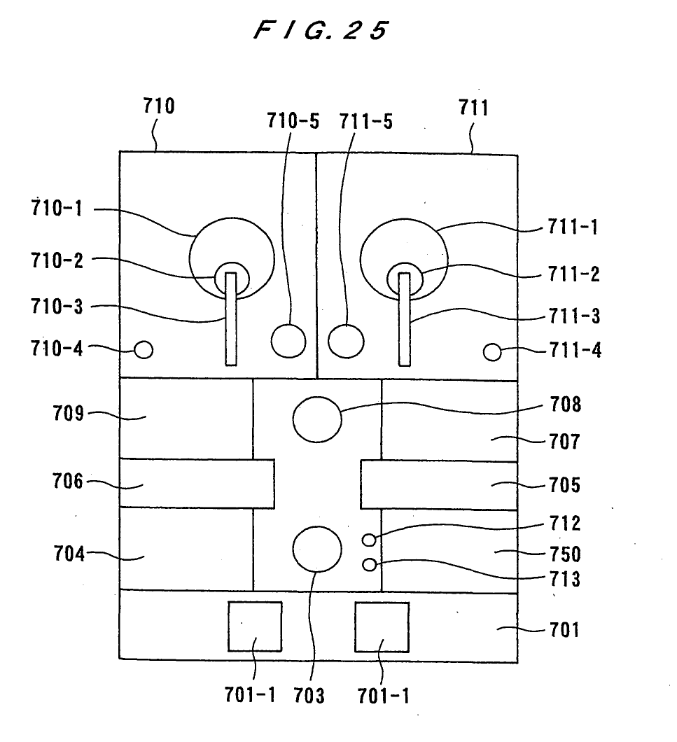

FIG. 25 is a view showing the plan constitution of another example of a semiconductor substrate processing apparatus. The substrate processing apparatus differs from the substrate processing apparatus shown in FIG. 24 in that a cap plating unit 750 is provided instead of the plated Cu film forming unit 702 in FIG. 24.

A cassette 701-1 accommodating the semiconductor substrates W formed plated Cu film is placed on a load port of a loading/unloading section 701. The semiconductor substrate W taken out from the cassette 701-1 is transferred to the first polishing apparatus 710 or second polishing apparatus 711 in which the surface of the plated Cu film is polished. After completion of polishing of the plated Cu film, the semiconductor substrate W is cleaned in the first cleaning machine 709.

After completion of cleaning in the first cleaning machine 709, the semiconductor substrate W is transferred to the cap plating unit 750 where cap plating is applied onto the surface of the plated Cu film with the aim of preventing oxidation of plated Cu film due to the atmosphere. The semiconductor substrate to which cap plating has been applied is carried by the second robot 708 from the cap plating unit 750 to the second cleaning unit 707 where it is cleaned with pure water or deionized water. The semiconductor substrate after completion of cleaning is returned into the cassette 701-1 placed on the loading/unloading section 701.

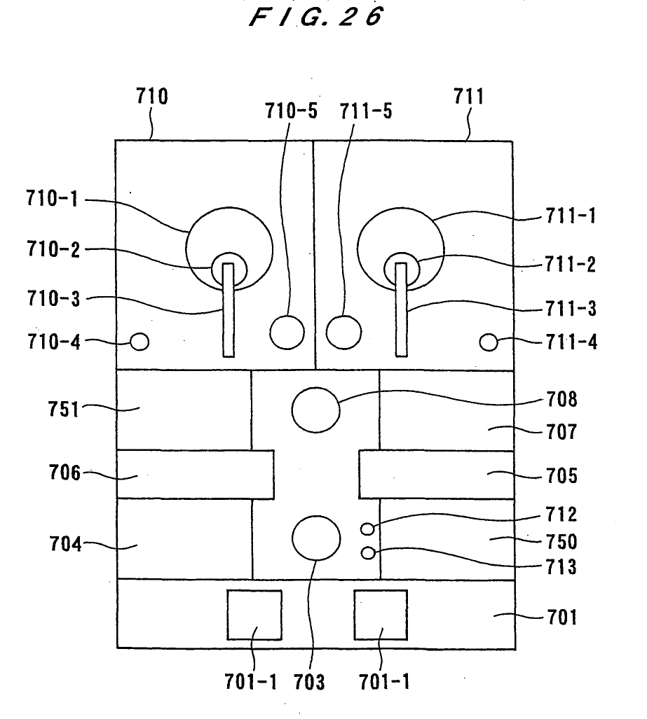

FIG. 26 is a view showing the plan constitution of still another example of a semiconductor substrate processing apparatus. The substrate processing apparatus differs from the substrate processing apparatus shown in FIG. 25 in that an annealing unit 751 is provided instead of the third cleaning machine 709 in FIG. 25.

The semiconductor substrate W, which is polished in the polishing unit 710 or 711, and cleaned in the first cleaning machine 709 described above, is transferred to the cap plating unit 750 where cap plating is applied onto the surface of the plated Cu film. The semiconductor substrate to which cap plating has been applied is carried by the second robot 732 from the cap plating unit 750 to the first cleaning unit 707 where it is cleaned.

After completion of cleaning in the first cleaning machine 709, the semiconductor substrate W is transferred to the annealing unit 751 in which the substrate is annealed, whereby the plated Cu film is alloyed so as to increase the electromigration resistance of the plated Cu film. The semiconductor substrate W to which annealing treatment has been applied is carried from the annealing unit 751 to the second cleaning unit 707 where it is cleaned with pure water or deionized water. The semiconductor substrate W after completion of cleaning is returned into the cassette 701-1 placed on the loading/unloading section 701.

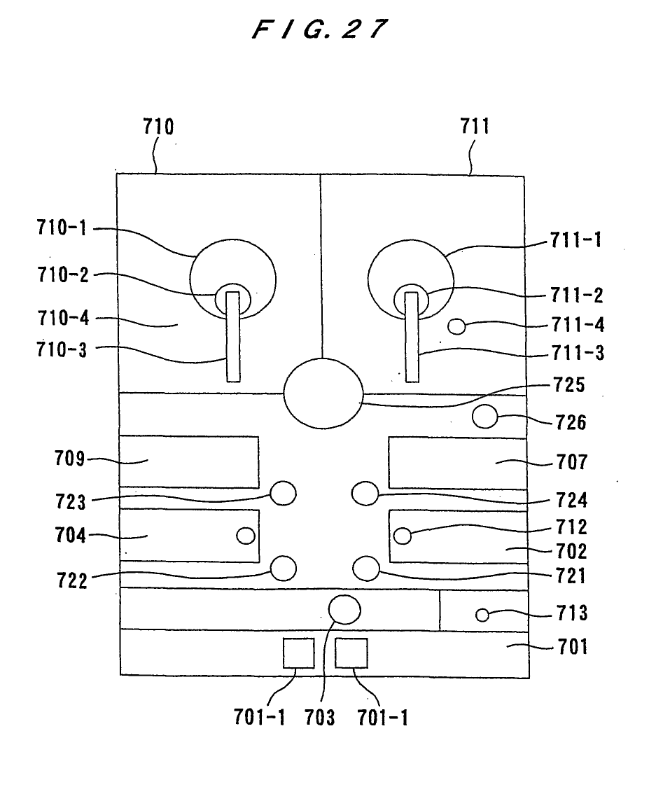

FIG. 27 is a view showing a plan layout constitution of another example of the substrate processing apparatus. In FIG. 27, portions denoted by the same reference numerals as those in FIG. 24 show the same or corresponding portions. In the substrate processing apparatus, a pusher indexer 725 is disposed close to a first polishing apparatus 710 and a second polishing apparatus 711. Substrate placing tables 721, 722 are disposed close to a third cleaning machine 704 and a plated Cu film forming unit 702, respectively. A robot 723 is disposed close to a first cleaning machine 709 and the third cleaning machine 704. Further, a robot 724 is disposed close to a second cleaning machine 707 and the plated Cu film forming unit 702, and a dry state film thickness measuring instrument 713 is disposed close to a loading/unloading section 701 and a first robot 703.

In the substrate processing apparatus of the above constitution, the first robot 703 takes out a semiconductor substrate W from a cassette 701-1 placed on the load port of the loading/unloading section 701. After the film thicknesses of a barrier layer and a seed layer are measured with the dry state film thickness measuring instrument 713, the first robot 703 places the semiconductor substrate W on the substrate placing table 721. In the case where the dry state film thickness measuring instrument 713 is provided on the hand of the first robot 703, the film thicknesses are measured thereon, and the substrate is placed on the substrate placing table 721. The second robot 723 transfers the semiconductor substrate W on the substrate placing table 721 to the plated Cu film forming unit 702 in which a plated Cu film is formed. After formation of the plated Cu film, the film thickness of the plated Cu film is measured with a before-plating and after-plating film thickness measuring instrument 712. Then, the second robot 723 transfers the semiconductor substrate W to the pusher indexer 725 and loads it thereon.

[Serial Mode]

In the serial mode, a top ring head 710-2 holds the semiconductor substrate W on the pusher indexer 725 by suction, transfers it to a polishing table 710-1, and presses the semiconductor substrate W against a polishing surface on the polishing table 710-1 to perform polishing. Detection of the end point of polishing is performed by the same method as described above. The semiconductor substrate W after completion of polishing is transferred to the pusher indexer 725 by the top ring head 710-2, and loaded thereon. The second robot 723 takes out the semiconductor substrate W, and carries it into the first cleaning machine 709 for cleaning. Then, the semiconductor substrate W is transferred to the pusher indexer 725, and loaded thereon.

A top ring head 711-2 holds the semiconductor substrate W on the pusher indexer 725 by suction, transfers it to a polishing table 711-1, and presses the semiconductor substrate W against a polishing surface on the polishing table 711-1 to perform polishing. Detection of the end point of polishing is performed by the same method as described above. The semiconductor substrate W after completion of polishing is transferred to the pusher indexer 725 by the top ring head 711-2, and loaded thereon. The third robot 724 picks up the semiconductor substrate W, and its film thickness is measured with a film thickness measuring instrument 726. Then, the semiconductor substrate W is carried into the second cleaning machine 707 for cleaning. Thereafter, the semiconductor substrate W is carried into the third cleaning machine 704, where it is cleaned and then dried by spin-drying. Then, the semiconductor substrate W is picked up by the third robot 724, and placed on the substrate placing table 722.

[Parallel Mode]

In the parallel mode, the top ring head 710-2 or 711-2 holds the semiconductor substrate W on the pusher indexer 725 by suction, transfers it to the polishing table 710-1 or 711-1, and presses the semiconductor substrate W against the polishing surface on the polishing table 710-1 or 711-1 to perform polishing. After measurement of the film thickness, the third robot 724 picks up the semiconductor substrate W, and places it on the substrate placing table 722.

The first robot 703 transfers the semiconductor substrate W on the substrate placing table 722 to the dry state film thickness measuring instrument 713. After the film thickness is measured, the semiconductor substrate W is returned to the cassette 701-1 of the loading/unloading section 701.

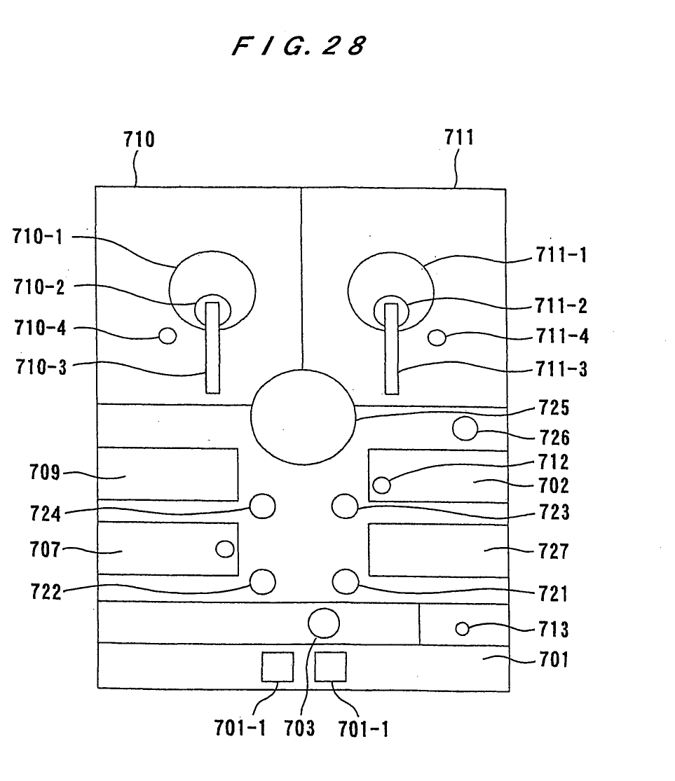

FIG. 28 is a view showing another plan layout constitution of the substrate processing apparatus. The substrate processing apparatus is such a substrate processing apparatus which forms a seed layer and a plated Cu film on a semiconductor substrate W having no seed layer formed thereon, and polishes these films to form interconnects.

In the substrate polishing apparatus, a pusher indexer 725 is disposed close to a first polishing apparatus 710 and a second polishing apparatus 711, substrate placing tables 721, 722 are disposed close to a second cleaning machine 707 and a seed layer forming unit 727, respectively, and a robot 723 is disposed close to the seed layer forming unit 727 and a plated Cu film forming unit 702. Further, a robot 724 is disposed close to a first cleaning machine 709 and the second cleaning machine 707, and a dry state film thickness measuring instrument 713 is disposed close to a loading/unloading section 701 and a first robot 702.

The first robot 703 takes out a semiconductor substrate W having a barrier layer thereon from a cassette 701-1 placed on the load port of the loading/unloading section 701, and places it on the substrate placing table 721. Then, the second robot 723 transfers the semiconductor substrate W to the seed layer forming unit 727 where a seed layer is formed. The seed layer is formed by electroless-plating. The second robot 723 enables the semiconductor substrate having the seed layer formed thereon to be measured in thickness of the seed layer by the before-plating and after-plating film thickness measuring instrument 712. After measurement of the film thickness, the semiconductor substrate is carried into the plated Cu film forming unit 702 where a plated Cu film is formed.

After formation of the plated Cu film, its film thickness is measured, and the semiconductor substrate is transferred to a pusher indexer 725. A top ring 710-2 or 711-2 holds the semiconductor substrate W on the pusher indexer 725 by suction, and transfers it to a polishing table 710-1 or 711-1 to perform polishing. After polishing, the top ring 710-2 or 711-2 transfers the semiconductor substrate W to a film thickness measuring instrument 710-4 or 711-4 to measure the film thickness. Then, the top ring 710-2 or 711-2 transfers the semiconductor substrate W to the pusher indexer 725, and places it thereon.

Then, the third robot 724 picks up the semiconductor substrate W from the pusher indexer 725, and carries it into the first cleaning machine 709. The third robot 724 picks up the cleaned semiconductor substrate W from the first cleaning machine 709, carries it into the second cleaning machine 707, and places the cleaned and dried semiconductor substrate on the substrate placing table 722. Then, the first robot 703 picks up the semiconductor substrate W, and transfers it to the dry state film thickness measuring instrument 713 in which the film thickness is measured, and the first robot 703 carries it into the cassette 701-1 placed on the unload port of the loading/unloading section 701.

In the substrate processing apparatus shown in FIG. 28, interconnects are formed by forming a barrier layer, a seed layer and a plated Cu film on a semiconductor substrate W having a via hole or a trench of a circuit pattern formed therein, and polishing them.

The cassette 701-1 accommodating the semiconductor substrates W before formation of the barrier layer is placed on the load port of the loading/unloading section 701. The first robot 703 takes out the semiconductor substrate W from the cassette 701-1 placed on the load port of the loading/unloading section 701, and places it on the substrate, placing table 721. Then, the second robot 723 transfers the semiconductor substrate W to the seed layer forming unit 727 where a barrier layer and a seed layer are formed. The barrier layer and the seed layer are formed by electroless-plating. The second robot 723 brings the semiconductor substrate W having the barrier layer and the seed layer formed thereon to the before-plating and after-plating film thickness measuring instrument 712 which measures the film thicknesses of the barrier layer and the seed layer. After measurement of the film thicknesses, the semiconductor substrate W is carried into the plated Cu film forming unit 702 where a plated Cu film is formed.

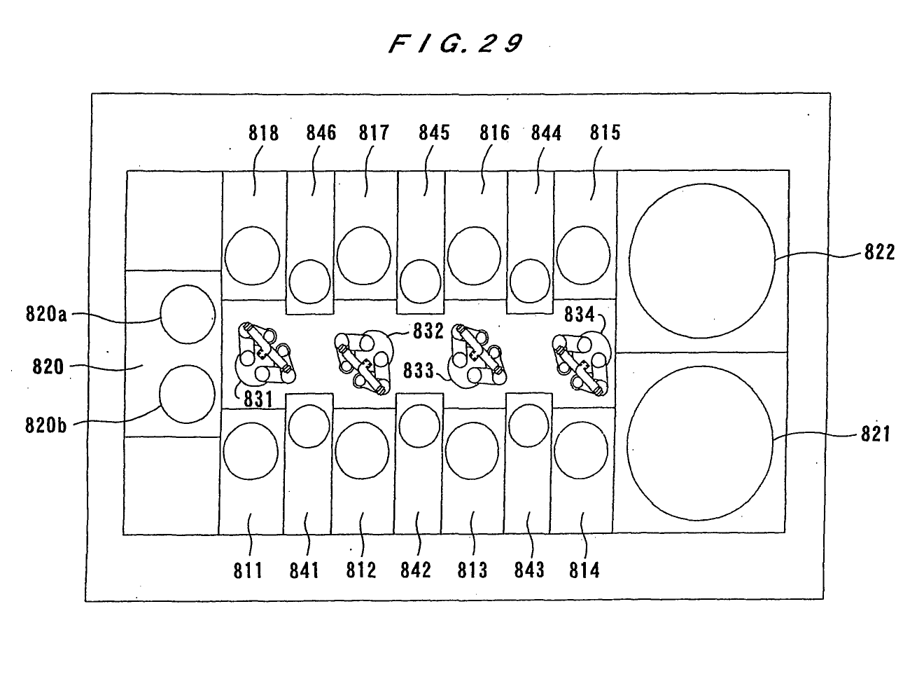

FIG. 29 is a view showing plan layout constitution of another example of the substrate processing apparatus. In the substrate processing apparatus, there are provided a barrier layer forming unit 811, a seed layer forming unit 812, a plated film forming unit 813, an annealing unit 814, a first cleaning unit 815, a bevel and backside cleaning unit 816, a cap plating unit 817, a second cleaning unit 818, a first aligner and film thickness measuring instrument 841, a second aligner and film thickness measuring instrument 842, a first substrate reversing machine 843, a second substrate reversing machine 844, a substrate temporary placing table 845, a third film thickness measuring instrument 846, a loading/unloading section 820, a first polishing apparatus 821, a second polishing apparatus 822, a first robot 831, a second robot 832, a third robot 833, and a fourth robot 834. The film thickness measuring instruments 841, 842, and 846 are units, have the same size as the frontage dimension of other units (plating, cleaning, annealing units, and the like), and are thus interchangeable.

In this example, an electroless Ru plating apparatus can be used as the barrier layer forming unit 811, an electroless Cu plating apparatus as the seed layer forming unit 812, and an electroplating apparatus as the plated film forming unit 813.

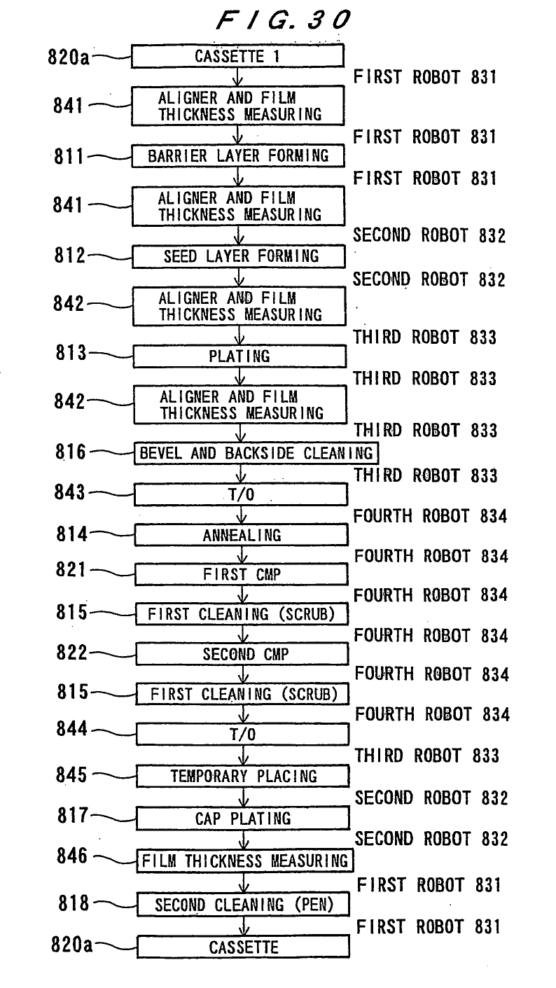

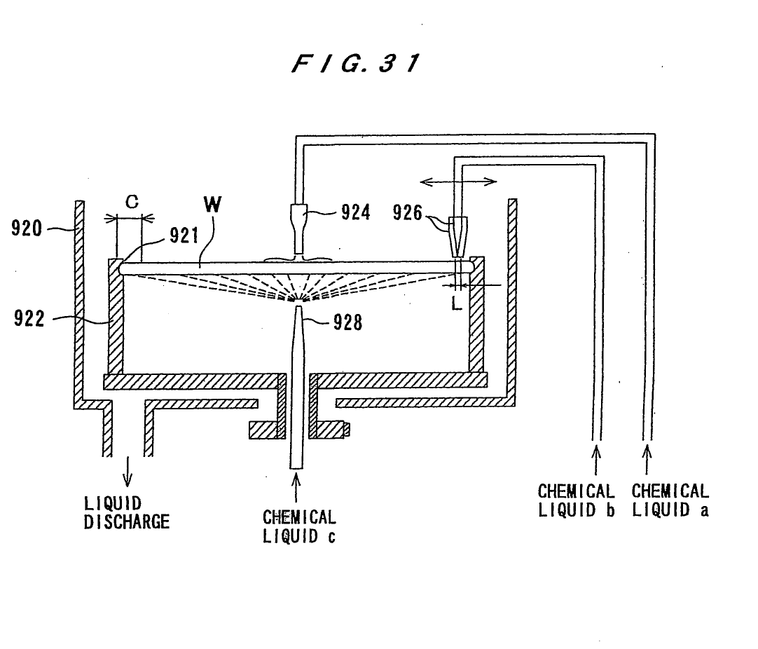

FIG. 30 is a flow chart showing the flow of the respective steps in the present substrate processing apparatus. The respective steps in the apparatus will be described according to this flow chart. First, a semiconductor substrate taken out by the first robot 831 from a cassette 826a placed on the load and unload unit 820 is placed in the first aligner and film thickness measuring unit 841, in such a state that its surface, to be plated, faces upward. In order to set a reference point for a position at which film thickness measurement is made, notch alignment for film thickness measurement is performed, and then film thickness data on the semiconductor substrate before formation of a Cu film are obtained.

Then, the semiconductor substrate is transferred to the barrier layer forming unit 811 by the first robot 831. The barrier layer forming unit 811 is such an apparatus for forming a barrier layer on the semiconductor substrate by electroless Ru plating, and the barrier layer forming unit 811 forms an Ru film as a film for preventing Cu from diffusing into an interlayer insulator film (e.g. SiO₂) of a semiconductor device. The semiconductor substrate discharged after cleaning and drying steps is transferred by the first robot 831 to the first aligner and film thickness measuring unit 841, where the film thickness of the semiconductor substrate, i.e., the film thickness of the barrier layer is measured.

The semiconductor substrate after film thickness measurement is carried into the seed layer forming unit 812 by the second robot 832, and a seed layer is formed on the barrier layer by electroless Cu plating. The semiconductor substrate discharged after cleaning and drying steps is transferred by the second robot 832 to the second aligner and film thickness measuring instrument 842 for determination of a notch position, before the semiconductor substrate is transferred to the plated film forming unit 813, which is an impregnation plating unit, and then notch alignment for Cu plating is performed by the film thickness measuring instrument 842. If necessary, the film thickness of the semiconductor substrate before formation of a Cu film may be measured again in the film thickness measuring instrument 842.

The semiconductor substrate which has completed notch alignment is transferred by the third robot 833 to the plated film forming unit 813 where Cu plating is applied to the semiconductor substrate. The semiconductor substrate discharged after cleaning and drying steps is transferred by the third robot 833 to the bevel and backside cleaning unit 816 where an unnecessary Cu film (seed layer) at a peripheral portion of the semiconductor substrate is removed. In the bevel and backside cleaning unit 816, the bevel is etched in a preset time, and Cu adhering to the backside of the semiconductor substrate is cleaned with a chemical liquid such as hydrofluoric acid. At this time, before transferring the semiconductor substrate to the bevel and backside cleaning unit 816, film thickness measurement of the semiconductor substrate may be made by the second aligner and film thickness measuring instrument 842 to obtain the thickness value of the Cu film formed by plating, and based on the obtained results, the bevel etching time may be changed arbitrarily to carry out etching. The region etched by bevel etching is a region which corresponds to a peripheral edge portion of the substrate and has no circuit formed therein, or a region which is not utilized finally as a chip although a circuit is formed. A bevel portion is included in this region.

The semiconductor substrate discharged after cleaning and drying steps in the bevel and backside cleaning unit 816 is transferred by the third robot 833 to the substrate reversing machine 843. After the semiconductor substrate is turned over by the substrate reversing machine 843 to cause the plated surface to be directed downward, the semiconductor substrate is introduced into the annealing unit 814 by the fourth robot 834 for thereby stabilizing a interconnection portion. Before and/or after annealing treatment, the semiconductor substrate is carried into the second aligner and film thickness measuring unit 842 where the film thickness of a copper film formed on the semiconductor substrate is measured. Then, the semiconductor substrate is carried by the fourth robot 834 into the first polishing apparatus 821 in which the Cu film and the seed layer of the semiconductor substrate are polished.

At this time, desired abrasive grains or the like are used, but fixed abrasive may be used in order to prevent dishing and enhance flatness of the face. After completion of primary polishing, the semiconductor substrate is transferred by the fourth robot 834 to the first cleaning unit 815 where it is cleaned. This cleaning is scrub-cleaning in which rolls having substantially the same length as the diameter of the semiconductor substrate are placed on the face and the backside of the semiconductor substrate, and the semiconductor substrate and the rolls are rotated, while pure water or deionized water is flowed, thereby performing cleaning of the semiconductor substrate.

After completion of the primary cleaning, the semiconductor substrate is transferred by the fourth robot 834 to the second polishing apparatus 822 where the barrier layer on the semiconductor substrate is polished. At this time, desired abrasive grains or the like are used, but fixed abrasive may be used in order to prevent dishing and enhance flatness of the face. After completion of secondary polishing, the semiconductor substrate is transferred by the fourth robot 834 again to the first cleaning unit 815 where scrub-cleaning is performed. After completion of cleaning, the semiconductor substrate is transferred by the fourth robot 834 to the second substrate reversing machine 844 where the semiconductor substrate is reversed to cause the plated surface to be directed upward, and then the semiconductor substrate is placed on the substrate temporary placing table 845 by the third robot.

The semiconductor substrate is transferred by the second robot 832 from the substrate temporary placing table 845 to the cap plating unit 817 where cap plating is applied onto the Cu surface with the aim of preventing oxidation of Cu due to the atmosphere. The semiconductor substrate to which cap plating has been applied is carried by the second robot 832 from the cover plating unit 817 to the third film thickness measuring instrument 146 where the thickness of the copper film is measured. Thereafter, the semiconductor substrate is carried by the first robot 831 into the second cleaning unit 818 where it is cleaned with pure water or deionized water. The semiconductor substrate after completion of cleaning is returned into the cassette 820a placed on the loading/unloading section 820.

The aligner and film thickness measuring instrument 841 and the aligner and film thickness measuring instrument 842 perform positioning of the notch portion of the substrate and measurement of the film thickness.

The seed layer forming unit 182 may be omitted. In this case, a plated film may be formed on a barrier layer directly in a plated film forming unit 817.

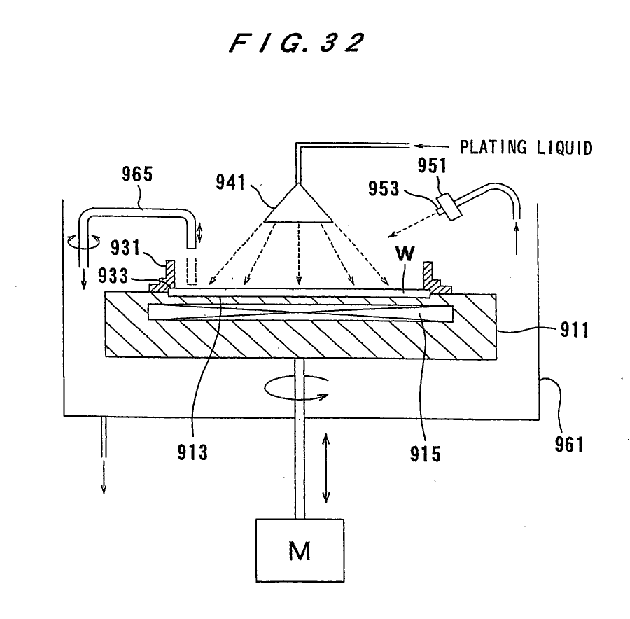

The bevel and backside cleaning unit 816 can perform an edge (bevel) Cu etching and a backside cleaning at the same time, and can suppress growth of a natural oxide film of copper at the circuit formation portion on the surface of the substrate. FIG. 31 shows a schematic view of the bevel and backside cleaning unit 816. As shown in FIG. 31, the bevel and backside cleaning unit 816 has a substrate holding portion 922 positioned inside a bottomed cylindrical waterproof cover 920 and adapted to rotate a substrate W at a high speed, in such a state that the face of the substrate W faces upwardly, while holding the substrate W horizontally by spin chucks 921 at a plurality of locations along a circumferential direction of a peripheral edge portion of the substrate; a center nozzle 924 placed above a nearly central portion of the face of the substrate W held by the substrate holding portion 922; and an edge nozzle 926 placed above the peripheral edge portion of the substrate W. The center nozzle 924 and the edge nozzle 926 are directed downward. A back nozzle 928 is positioned below a nearly central portion of the backside of the substrate W, and directed upward. The edge nozzle 926 is adapted to be movable in a diametrical direction and a height direction of the substrate W.

The width of movement L of the edge nozzle 926 is set such that the edge nozzle 926 can be arbitrarily positioned in a direction toward the center from the outer peripheral end surface of the substrate, and a set value for L is inputted according to the size, usage, or the like of the substrate W. Normally, an edge cut width C is set in the range of 2 mm to 5 mm. In the case where a rotational speed of the substrate is a certain value or higher at which the amount of liquid migration from the backside to the face is not problematic, the copper film within the edge cut width C can be removed.

Next, the method of cleaning with this cleaning apparatus will be described. First, the semiconductor substrate W is horizontally rotated integrally with the substrate holding portion 922, with the substrate being held horizontally by the spin chucks 921 of the substrate holding port on 922. In this state, an acid solution is supplied from the center nozzle 924 to the central portion of the face of the substrate W. The acid solution may be a non-oxidizing acid, and hydrofluoric acid, hydrochloric acid, sulfuric acid, citric acid, oxalic acid, or the like is used. On the other hand, an oxidizing agent solution is supplied continuously or intermittently from the edge nozzle 926 to the peripheral edge portion of the substrate W. As the oxidizing agent solution, one of an aqueous solution of ozone, an aqueous solution of hydrogen peroxide, an aqueous solution of nitric acid, and an aqueous solution of sodium hypochlorite is used, or a combination of these is used.

In this manner, the copper film, or the like formed on the upper surface and end surface in the region of the peripheral edge portion C of the semiconductor substrate W is rapidly oxidized with the oxidizing agent solution, and is simultaneously etched with the acid solution supplied from the center nozzle 924 and spread on the entire face of the substrate, whereby it is dissolved and removed. By mixing the acid solution and the oxidizing agent solution at the peripheral edge portion of the substrate, a steep etching profile can be obtained, in comparison with a mixture of them which is produced in advance being supplied. At this time, the copper etching rate is determined by their concentrations. If a natural oxide film of copper is formed in the circuit-formed portion on the face of the substrate, this natural oxide is immediately removed by the acid solution spreading on the entire face of the substrate according to rotation of the substrate, and does not grow any more. After the supply of the acid solution from the center nozzle 924 is stopped, the supply of the oxidizing agent solution from the edge nozzle 926 is stopped. As a result, silicon exposed on the surface is oxidized, and deposition of copper can be suppressed.

On the other hand, an oxidizing agent solution and a silicon oxide film etching agent are supplied simultaneously or alternately from the back nozzle 928 to the central portion of the backside of the substrate. Therefore, copper or the like adhering in a metal form to the backside of the semiconductor substrate W can be oxidized with the oxidizing agent solution, together with silicon of the substrate, and can be etched and removed with the silicon oxide film etching agent. This oxidizing agent solution is preferably the same as the oxidizing agent solution supplied to the face, because the types of chemicals are decreased in number. Hydrofluoric acid can be used as the silicon oxide film etching agent, and if hydrofluoric acid is used as the acid solution on the face of the substrate, the types of chemicals can be decreased in number. Thus, if the supply of the oxidizing agent is stopped first, a hydrophobic surface is obtained. If the etching agent solution is stopped first, a water-saturated surface (a hydrophilic surface) is obtained, and thus the backside surface can be adjusted to a condition which will satisfy the requirements of a subsequent process.

In this manner, the acid solution, i.e., etching solution is supplied to the substrate to remove metal ions remaining on the surface of the substrate W. Then, pure water is supplied to replace the etching solution with pure water and remove the etching solution, and then the substrate is dried by spin-drying. In this way, removal of the copper film in the edge cut width C at the peripheral edge portion on the face of the semiconductor substrate, and removal of copper contaminants on the backside are performed simultaneously to thus allow this treatment to be completed, for example, within 80 seconds. The etching cut width of the edge can be set arbitrarily (from 2 to 5 mm), but the time required for etching does not depend on the cut width.

Annealing treatment performed before the CMP process and after plating has a favorable effect on the subsequent CMP treatment and on the electrical characteristics of interconnection. Observation of the surface of broad interconnection (unit of several micrometers) after the CMP treatment without annealing showed many defects such as microvoids, which resulted in an increase in the electrical resistance of the entire interconnection. Execution of annealing ameliorated the increase in the electrical resistance. In the absence of annealing, thin interconnection showed no voids. Thus, the degree of grain growth is presumed to be involved in these phenomena. That is, the following mechanism can be speculated: Grain growth is difficult to occur in thin interconnection. In broad interconnection, on the other hand, grain growth proceeds in accordance with annealing treatment. During the process of grain growth, ultra-fine pores in the plated film, which are too small to be seen by the SEM (scanning electron microscope), gather and move upward, thus forming microvoid-like depressions in the upper part of the interconnection. The annealing conditions in the annealing unit 814 are such that hydrogen (2% or less) is added in a gas atmosphere, the temperature is in the range of 300° C. to 400° C., and the time is in the range of 1 to 5 minutes. Under these conditions, the above effects were obtained.

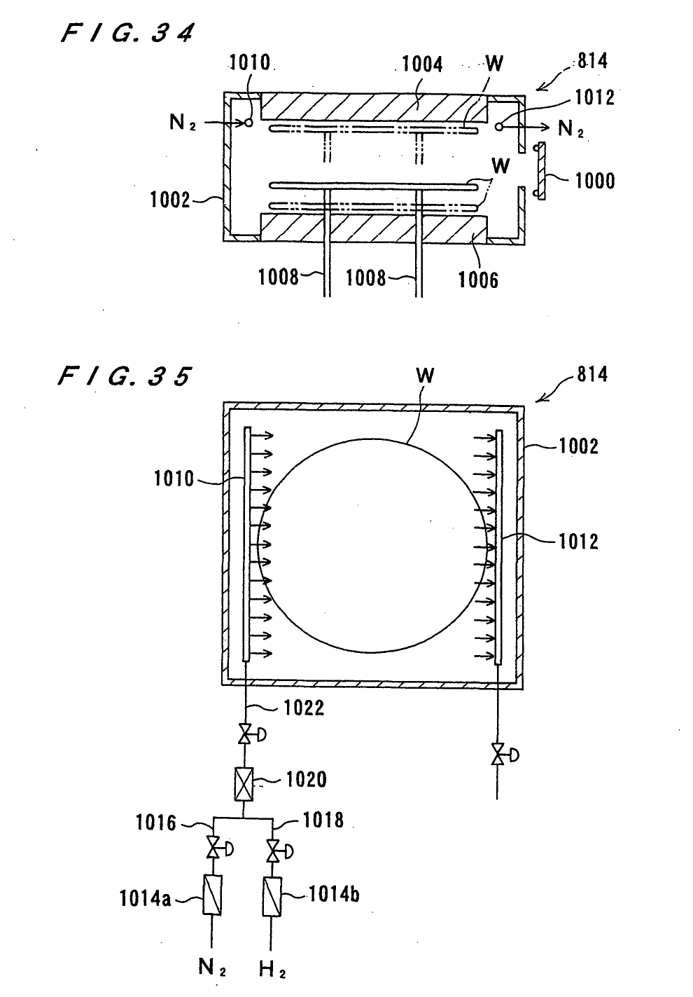

FIGS. 34 and 35 show the annealing unit 814. The annealing unit 814 comprises a chamber 1002 having a gate 1000 for taking in and taking out the semiconductor substrate W, a hot plate 1004 disposed at an upper position in the chamber 1002 for heating the semiconductor substrate W to e.g. 400° C., and a cool plate 1006 disposed at a lower position in the chamber 1002 for cooling the semiconductor substrate W by, for example, flowing a cooling water inside the plate. The annealing unit 1002 also has a plurality of vertically movable elevating pins 1008 penetrating the cool plate 1006 and extending upward and downward therethrough for placing and holding the semiconductor substrate W on them. The annealing unit further includes a gas introduction pipe 1010 for introducing an antioxidant gas between the semiconductor substrate W and the hot plate 1004 during annealing, and a gas discharge pipe 1012 for discharging the gas which has been introduced from the gas introduction pipe 1010 and flowed between the semiconductor substrate W and the hot plate 1004. The pipes 1010 and 1012 are disposed on the opposite sides of the hot plate 1004.

The gas introduction pipe 1010 is connected to a mixed gas introduction line 1022 which in turn is connected to a mixer 1020 where a N₂ gas introduced through a N₂ gas introduction line 1016 containing a filter 1014a, and a H₂ gas introduced through a H₂ gas introduction line 1018 containing a filter 1014b, are mixed to form a mixed gas which flows through the line 1022 into the gas introduction pipe 1010.

In operation, the semiconductor substrate W, which has been carried in the chamber 1002 through the gate 1000, is held on the elevating pins 1008 and the elevating pins 1008 are raised up to a position at which the distance between the semiconductor substrate W held on the lifting pins 1008 and the hot plate 1004 becomes e.g. 0.1-1.0 mm. In this state, the semiconductor substrate W is then heated to e.g. 400° C. through the hot plate 1004 and, at the same time, the antioxidant gas is introduced from the gas introduction pipe 1010 and the gas is allowed to flow between the semiconductor substrate W and the hot plate 1004 while the gas is discharged from the gas discharge pipe 1012, thereby annealing the semiconductor substrate W while preventing its oxidation. The annealing treatment may be completed in about several tens of seconds to 60 seconds. The heating temperature of the substrate may be selected in the range of 100-600° C.

After the completion of the annealing, the elevating pins 1008 are lowered down to a position at which the distance between the semiconductor substrate W held on the elevating pins 1008 and the cool plate 1006 becomes e.g. 0-0.5 mm. In this state, by introducing a cooling water into the cool plate 1006, the semiconductor substrate W is cooled by the cool plate to a temperature of 100° C. or lower in e.g. 10-60 seconds. The cooled semiconductor substrate is sent to the next step.

A mixed gas of N₂ gas with several % of H₂ gas is used as the above antioxidant gas. However, N₂ gas may be used singly.

The annealing unit may be placed in the electroplating apparatus.

FIG. 32 is a schematic constitution drawing of the electroless-plating apparatus. As shown in FIG. 32, this electroless-plating apparatus comprises holding means 911 for holding a semiconductor substrate W to be plated on its upper surface, a dam member 931 for contacting a peripheral edge portion of a surface to be plated (upper surface) of the semiconductor substrate W held by the holding means 911 to seal the peripheral edge portion, and a shower head 941 for supplying a plating solution to the surface, to be plated, of the semiconductor substrate W having the peripheral edge portion sealed with the dam member 931. The electroless-plating apparatus further comprises cleaning liquid supply means 951 disposed near an upper outer periphery of the holding means 911 for supplying a cleaning liquid to the surface, to be plated, of the semiconductor substrate W, a recovery vessel 961 for recovering a cleaning liquid or the like (plating waste liquid) discharged, a plating solution recovery nozzle 965 for sucking in and recovering the plating solution held on the semiconductor substrate W, and a motor M for rotationally driving the holding means 911. The respective members will be described below.

The holding means 911 has a substrate placing portion 913 on its upper surface for placing and holding the semiconductor substrate W. The substrate placing portion 913 is adapted to place and fix the semiconductor substrate W. Specifically, the substrate placing portion 913 has a vacuum attracting mechanism (not shown) for attracting the semiconductor substrate W to a backside thereof by vacuum suction. A backside heater 915, which is planar and heats the surface, to be plated, of the semiconductor substrate W from underside to keep it warm, is installed on the backside of the substrate placing portion 913. The backside heater 915 is composed of, for example, a rubber heater. This holding means 911 is adapted to be rotated by the motor M and is movable vertically by raising and lowering means (not shown).

The dam member 931 is tubular, has a seal portion 933 provided in a lower portion thereof for sealing the outer peripheral edge of the semiconductor substrate W, and is installed so as not to move vertically from the illustrated position.

The shower head 941 is of a structure having many nozzles provided at the front end for scattering the supplied plating solution in a shower form and supplying it substantially uniformly to the surface, to be plated, of the semiconductor substrate W. The cleaning liquid supply means 951 has a structure for ejecting a cleaning liquid from a nozzle 953.

The plating solution recovery nozzle 965 is adapted to be movable upward and downward and swingable, and the front end of the plating solution recovery nozzle 965 is adapted to be lowered inwardly of the dam member 931 located on the upper surface peripheral edge portion of the semiconductor substrate W and to suck in the plating solution on the semiconductor substrate W.

Next, the operation of the electroless-plating apparatus will be described. First, the holding means 911 is lowered from the illustrated state to provide a gap of a predetermined dimension between the holding means 911 and the dam member 931, and the semiconductor substrate W is placed on and fixed to the substrate placing portion 913. An 8 inch substrate, for example, is used as the semiconductor substrate W.

Then, the holding means 911 is raised to bring its upper surface into contact with the lower surface of the dam member 931 as illustrated, and the outer periphery of the semiconductor substrate W is sealed with the seal portion 933 of the dam member 931. At this time, the surface of the semiconductor substrate W is in an open state.

Then, the semiconductor substrate W itself is directly heated by the backside heater 915 to render the temperature of the semiconductor substrate W, for example, 70° C. (maintained until termination of plating). Then, the plating solution heated, for example, to 50° C. is ejected from the shower head 941 to pour the plating solution over substantially the entire surface of the semiconductor substrate W. Since the surface of the semiconductor substrate W is surrounded by the dame member 931, the poured plating solution is all held on the surface of the semiconductor substrate W. The amount of the supplied plating solution may be a small amount which will become a 1 mm thickness (about 30 ml) on the surface of the semiconductor substrate W. The depth of the plating solution held on the surface to be plated may be 10 mm or less, and may be even 1 mm as in this embodiment. If a small amount of the supplied plating solution is sufficient, the heating apparatus for heating the plating solution may be of a small size. In this example, the temperature of the semiconductor substrate W is raised to 70° C., and the temperature of the plating solution is raised to 50° C. by heating. Thus, the surface, to be plated, of the semiconductor substrate W becomes, for example, 60° C., and hence a temperature optimal for a plating reaction in this example can be achieved.

The semiconductor substrate W is instantaneously rotated by the motor M to perform uniform liquid wetting of the surface to be plated, and then plating of the surface to be plated is performed in such a state that the semiconductor substrate W is in a stationary state. Specifically, the semiconductor substrate W is rotated at 100 rpm or less for only 1 second to uniformly wet the surface, to be plated, of the semiconductor substrate W with the plating solution. Then, the semiconductor substrate W is kept stationary, and electroless-plating is performed for 1 minute. The instantaneous rotating time is 10 seconds or less at the longest.

After completion of the plating treatment, the front end of the plating solution recovery nozzle 965 is lowered to an area near the inside of the dam member 931 on the peripheral edge portion of the semiconductor substrate W to suck in the plating solution. At this time, if the semiconductor substrate W is rotated at a rotational speed of, for example, 100 rpm or less, the plating solution remaining on the semiconductor substrate W can be gathered in the portion of the dam member 931 on the peripheral edge portion of the semiconductor substrate W under centrifugal force, so that recovery of the plating solution can be performed with a good efficiency and a high recovery rate. The holding means 911 is lowered to separate the semiconductor substrate W from the dam member 931. The semiconductor substrate W is started to be rotated, and the cleaning liquid (ultra-pure water) is jetted at the plated surface of the semiconductor substrate W from the nozzle 953 of the cleaning liquid supply means 951 to cool the plated surface, and simultaneously perform dilution and cleaning, thereby stopping the electroless-plating reaction. At this time, the cleaning liquid jetted from the nozzle 953 may be supplied to the dam member 931 to perform cleaning of the dam member 931 at the same time. The plating waste liquid at this time is recovered into the recovery vessel 961 and discarded.

Then, the semiconductor substrate W is rotated at a high speed by the motor M for spin-drying, and then the semiconductor substrate W is removed from the holding means 911.

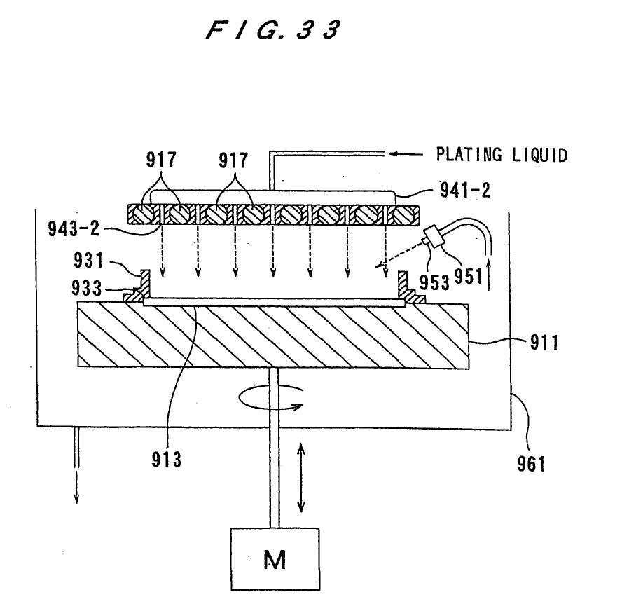

FIG. 33 is a schematic constitution drawing of another electroless-plating. The electroless-plating apparatus of FIG. 33 is different from the electroless-plating apparatus of FIG. 32 in that instead of providing the backside heater 915 in the holding means 911, lamp heaters 917 are disposed above the holding means 911, and the lamp heaters 917 and a shower head 941-2 are integrated. For example, a plurality of ring-shaped lamp heaters 917 having different radii are provided concentrically, and many nozzles 943-2 of the shower head 941-2 are open in a ring form from the gaps between the lamp heaters 917. The lamp heaters 917 may be composed of a single spiral lamp heater, or may be composed of other lamp heaters of various structures and arrangements.

Even with this constitution, the plating solution can be supplied from each nozzle 943-2 to the surface, to be plated, of the semiconductor substrate W substantially uniformly in a shower form. Further, heating and heat retention of the semiconductor substrate W can be performed by the lamp heaters 917 directly uniformly. The lamp heaters 917 heat not only the semiconductor substrate W and the plating solution, but also ambient air, thus exhibiting a heat retention effect on the semiconductor substrate W.

Direct heating of the semiconductor substrate W by the lamp heaters 917 requires the lamp heaters 917 with a relatively large electric power consumption. In place of such lamp heaters 917, lamp heaters 917 with a relatively small electric power consumption and the backside heater 915 shown in FIG. 31 may be used in combination to heat the semiconductor substrate W mainly with the backside heater 915 and to perform heat retention of the plating solution and ambient air mainly by the lamp heaters 917. In the same manner as in the aforementioned embodiment, means for directly or indirectly cooling the semiconductor substrate W may be provided to perform temperature control.

The cap plating described above is preferably performed by electroless-plating process, but may be performed by electroplating process.

The present invention will now be illustrated by the following working examples.

First, copper-plating solutions (the present plating solutions) having the complex bath compositions 1-8 shown in Table 1 and copper-plating solutions (comparative plating solutions) having the complex bath compositions 9 and 10 also shown in Table 1, and copper-plating solutions having the copper sulfate bath compositions 1 and 2 shown in Table 2 were prepared. FIG. 17 shows current-voltage curves for the complex bath 7 when the amount of the organic sulfur compound (III-(4)) is varied as: 0 ppm, 1 ppm, 5 ppm, 10 ppm and 25 ppm. As can be seen from FIG. 17, the addition of the organic sulfur compound raises the cathodic polarization, and the cathodic polarization increases with the increase in the amount of the organic sulfur compound added.

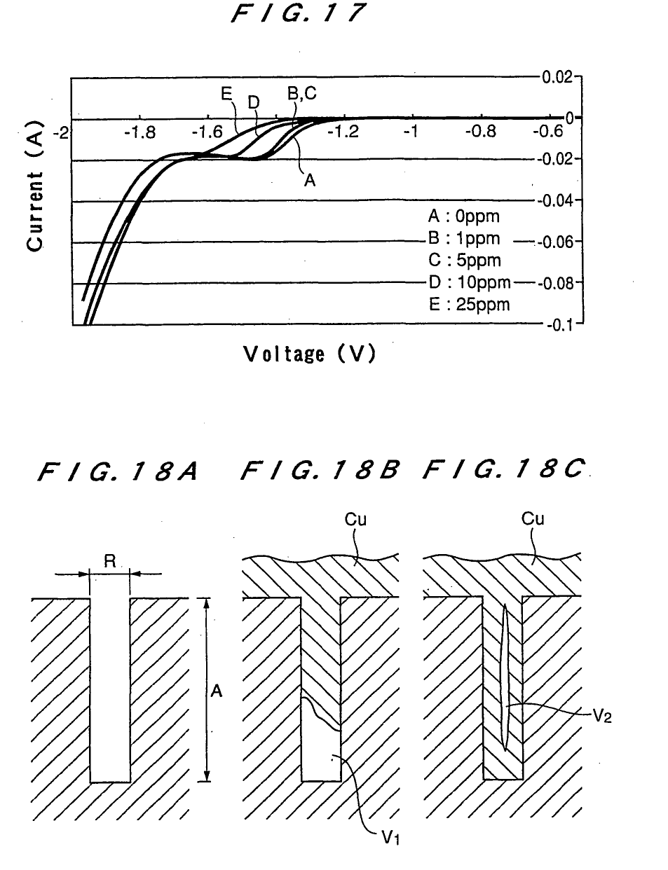

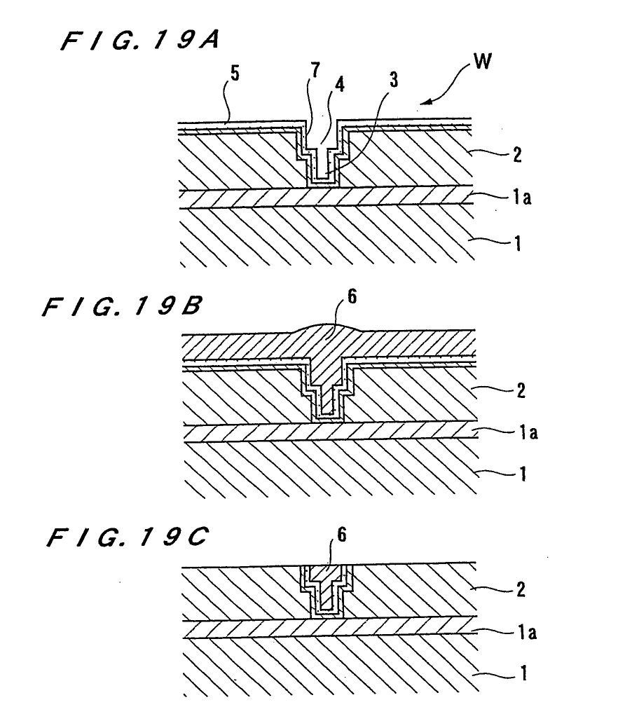

In Table 1, the organic sulfur compound “I-(10)” indicates that the above-described compound (10) of Group I was used as the organic sulfur compound; similarly, “II-(2)” and “III-(4)” indicates the use of the compound (2) of Group II and the compound (4) of Group III, respectively. In the following examples, plating with copper was carried out onto a substrate having in its surface via holes as shown in FIG. 18A, having a diameter of 0.2 μm and an aspect ratio A/R of 5 (depth: 1 μm) to fill the via holes with copper. The state of the copper thus filled in the via holes was observed under SEM (scanning electron microscope) to examine the presence or absence of defects. In the following description, the wording “bottom void” refers to such a state as shown in FIG. 18B: no deposition of copper at the bottom of the via hole, with void V₁ being formed; and the wording “seam void” refers to the formation of a seam-like void V₂ in copper, as shown in FIG. 18C.

TABLE 1

| | A | B | C | D | E |
|---|---|---|---|---|---|
| | Type/Conc. | Type/Conc. | Type/pH | Type/Conc. | Type/Conc. |
| Complex bath composition 1 | Copper sulfate/ | EDA/ | Ammonia/ | I-(10)/ | PEG2000/ |
| (the present plating solution) | 5 g/L | 40 g/L | 9.5 | 100 mg/L | 10000 mg/L |
| Complex bath composition 2 | Copper sulfate/ | EDTA/ | Choline/ | I-(10)/ | Not used |
| (the present plating solution) | 20 g/L | 40 g/L | 9.0 | 100 mg/L | |
| Complex bath composition 3 | Copper sulfate/ | Pyrophosphoric | Choline/ | II-(2)/ | PPO750/ |
| (the present plating solution) | 20 g/L | acid/40 g/L | 9.0 | 5 mg/L | 100 mg/L |
| Complex bath composition 4 | Copper oxide/ | HEDTA/ | TMAH/ | II-(2)/ | PPO750/ |
| (the present plating solution) | 10 g/L | 40 g/L | 8.5 | 5 mg/L | 100 mg/L |
| Complex bath composition 5 | Copper oxide/ | DETA + TEPA/ | Ammonia/ | I-(10)/ | PPO750/ |
| (the present plating solution) | 15 g/L | 50 g/L + 30 g/L | 10.0 | 5 mg/L | 100 mg/L |
| Complex bath composition 6 | Copper | Potassium | KOH/ | II-(2)/ | PEG2000/ |
| (the present plating solution) | Pyrophosphate/ | Pyrophosphate/ | 8.5 | 50 mg/L | 1000 mg/L |
| | 80 g/L | 300 g/L | | | |
| Complex bath composition 7 | Copper | Pyrophosphoric | TMAH/ | III-(4)/ | Not used |
| (the present plating solution) | Pyrophosphate/ | acid/ | 10.0 | 10 mg/L | |
| | 15 g/L | 100 g/L | | | |
| Complex bath composition 9 | Copper | Sodium | Sodium | III-(4)/ | Not used |
| (the present plating solution) | cyanide/ | cyanide/40 g/L | cyanide/ | 100 mg/L | |
| | 30 g/L | | 12.0 | | |
| Complex bath composition 9 | Copper sulfate/ | Pyrophosphoric | Choline/ | Not used | Not used |
| (comparative plating solution) | 20 g/L | acid/40 g/L | 9.0 | | |
| Complex bath Composition 10 | Copper oxide/ | HEDTA/ | TMAH/ | Not used | PEG2000/ |
| (comparative plating solution) | 10 g/L | 40 g/L | 8.5 | | 1000 mg/L |

Note:
A: Copper salt (g/L)
B: Complexing agent (g/L)
C: pH adjusting agent (g/L)
D: Organic sulfur compound (mg/L)
E: Surfactant (mg/L)

TABLE 2

| | A | B | C | D |
|---|---|---|---|---|
| Copper sulfate | 200 | 50 | 50 | 5 |
| composition 1 | | | | |
| Copper sulfate | 70 | 185 | 50 | 5 |
| composition 2 | | | | |

Note:
A: Copper sulfate (g/L)
B: Sulfuric acid (ml/L)
C: Hydrochloric acid (ml/L)
D: Organic additive (ml/L)

### EXAMPLE 1

By using the copper-plating solution having the complex bath composition 1 (the present plating solution) as the copper-plating solution to be used in the first plating section 522a according to the first embodiment of the present invention, a first-stage plating (reinforcement of seed layer) was carried out at a current density of 0.5 A/dm² for 25 seconds. Thereafter, by using the copper-plating solution having the copper sulfate bath composition 1 as the copper-plating solution for the second plating section 522b, a second-stage plating (filling with copper) was carried out at a current density of 2.5 A/dm² for 2 minutes.

The SEM observation revealed no voids in all of the via holes present in the entire surface of the substrate.

### EXAMPLE 2

By using the copper-plating solution having the complex bath composition 2 (the present plating solution) as the copper-plating solution to be used in the plating section 522 according to the second embodiment of the present invention, plating (filling with copper) was carried out at a current density of 1 A/dm² for 5 minutes.

The SEM observation revealed a few seam voids in certain via holes present in the peripheral region of the substrate.

### EXAMPLE 3

By using the copper-plating solution having the complex bath composition 3 (the present plating solution) as the copper-plating solution to be used in the first plating section 522a according to the first embodiment of the present invention, a first-stage plating (reinforcement of seed layer) was carried out at a current density of 0.5 A/dm² for 25 seconds. Therefore, by using the copper-plating solution having the copper sulfate bath composition 2 as the copper-plating solution for the second plating section 522b, a second-stage plating (filling with copper) was carried out at a current density of 2.5 A/dm² for 2 minutes.

The SEM observation revealed no voids in all of the via holes present in the substrate.

### EXAMPLE 4

By using the copper-plating solution having the complex bath composition 4 (the present plating solution) as the copper-plating solution to be used in the plating section 522 according to the second embodiment of the present invention, plating (filling with copper) was carried out at a current density of 1 A/dm² for 5 minutes.

The SEM observation revealed no voids in all of the via holes present in the substrate.

### EXAMPLE 5

By using the copper-plating solution having the complex bath composition 5 (the present plating solution) as the copper-plating solution to be used in the first plating section 522a according to the first embodiment of the present invention, a first-stage plating (reinforcement of seed layer) was carried out at a current density of 0.5 A/dm² for 25 seconds. Thereafter, by using the copper-plating solution having the copper sulfate bath composition 1 as the copper-plating solution for the second plating section 522b, a second-stage plating (filling with copper) was carried out at a current density of 2.5-A/dm² for 2 minutes.

The SEM observation revealed no voids in all of the via holes present in the substrate.

### EXAMPLE 6

By using the copper-plating solution having the complex bath composition 6 (the present plating solution) as the copper-plating solution to be used in the plating section 522 according to the second embodiment of the present invention, plating (filling with copper) was carried out at a current density of 1 A/dm² for 5 minutes.

The SEM observation revealed a few voids in certain via holes present in the peripheral region of the substrate.

### EXAMPLE 7

By using the copper-plating solution having the complex bath composition 7. (the present plating solution) as the copper-plating solution to be used in the first plating section 522a according to the first embodiment of the present invention, a first-stage plating (reinforcement of seed layer) was carried out at a current density of 0.5 A/dm² for 25 seconds. Thereafter, by using the copper-plating solution having the copper sulfate bath composition 2 as the copper-plating solution for the second plating section 522b, a second-stage plating (filling with copper) was carried out at a current density of 2.5 A/dm² for 2 minutes.

The SEM observation revealed no voids in all of the via holes present in the substrate.

### EXAMPLE 8

By using the copper-plating solution having the complex bath composition 7 (the present plating solution) as the copper-plating solution to be used in the plating section 522 according to the second embodiment of the present invention, plating (filling with copper) was carried out at a current density of 1 A/dm² for 5 minutes.

The SEM observation revealed no voids in all of the via holes present in the substrate.

### EXAMPLE 9

By using the copper-plating solution having the complex bath composition 8 (the present plating solution) as the copper-plating solution to be used in the first plating section 522a according to the first embodiment of the present invention, a first-stage plating (reinforcement of seed layer) was carried out at a current density of 0.5 A/dm² for 25 seconds. Thereafter, by using the copper-plating solution having the copper sulfate bath composition 2 as the copper-plating solution for the second plating section 522b, a second-stage plating (filling with copper) was carried out at a current density of 2.5 A/dm² for 2 minutes.

The SEM observation revealed no voids in all of the via holes present in the substrate.

### COMPARATIVE EXAMPLE 1

By using the copper-plating solution having the copper sulfate bath composition 1, plating (filling with copper) was carried out at a current density of 2.5 A/dm² for 2 minutes.

The SEM observation revealed bottom voids in all of the via holes present in the substrate, each void occupying almost the lower half of the via hole.

### COMPARATIVE EXAMPLE 2

By using the copper-plating solution having the copper sulfate bath composition 2, plating (filling with copper) was carried out at a current density of 2.5 A/dm² for 2 minutes.

The SEM observation revealed bottom voids in all of the via holes present in the substrate, each void occupying about ½ ⅔ of the via hole.

### COMPARATIVE EXAMPLE 3

By using the copper-plating solution having the complex bath composition 9 (comparative plating solution) as the copper-plating solution to be used in the first plating section 522a according to the first embodiment of the present invention, a first-stage plating (reinforcement of seed layer) was carried out at a current density of 0.5 A/dm² for 25 seconds. Thereafter, by using the copper-plating solution having the copper sulfate bath composition 1 as the copper-plating solution for the second plating section 522b, a second-stage plating (filling with copper) was carried out at a current density of 2.5 A/dm² for 2 minutes.

The SEM observation revealed that though no voids were formed in the via holes present in the central region of the substrate, bottom voids were formed in the via holes present in the peripheral region of the substrate, each void occupying about ⅕ of the via hole.

### COMPARATIVE EXAMPLE 4

By using the copper-plating solution having the complex bath composition 10 (comparative plating solution) as the copper-plating solution to be used in the first plating section 522a according to the first embodiment of the present invention, a first-stage plating (reinforcement of seed layer) was carried out at a current density of 0.5 A/dm² for 25 seconds. Thereafter, by using the copper-plating solution having the copper sulfate bath composition 2 as the copper-plating solution for the second plating section 522b, a second-stage plating (filling with copper) was carried out at a current density of 2.5 A/dm² for 2 minutes.

The SEM observation revealed that though no voids were formed in the via holes present in the central region of the substrate, bottom voids were formed in the via holes present in the peripheral region of the substrate, each void occupying about ¼ of the via hole.

As described hereinabove, according to the present invention; the inclusion of the completing agent, and further of the organic sulfur compound as an additive, in the copper-plating solution can enhance the polarization of the plating bath and improve the uniform electrodeposition property. This enables reinforcement of the thin portion of a seed layer and uniform filling of copper into the depth of fine recesses, such as trenches and holes, having a high aspect ratio. Further, the deposited plating is dense, and is freed from micro-voids formation therein. The organic sulfur compound additive, due to its polarity, can be easily determined of its concentration by using an electrochemical measuring method, such as CVS method which is generally employed for measuring the concentration of an additive in a copper-plating solution. In addition, since the organic sulfur compound additive is very stable in the plating solution, the liquid management can be made with ease.

Although certain preferred embodiments of the present invention have been shown and described in detail, it should be understood that various changes and modifications may be made therein without departing from the scope of the appended claims.

### INDUSTRIAL APPLICABILITY

This invention relates a copper-plating solution, a plating method and a plating apparatus useful for forming copper interconnects by plating a semiconductor substrate to fill with copper fine recesses for interconnects formed in the surface of the substrate.

1. A copper-plating solution comprising monovalent or divalent copper ions, a completing agent, and an additive which restrains a copper chelate from taking off the chelate and depositing on the surface of a substrate.

2. The copper-plating solution according to claim 1, wherein the concentration of said copper ions is in the range of 0.1 to 100 g/l, the concentration of said completing agent is in the range of 0.1 to 500 g/l, the concentration of said additive is in the range of 0.1 to 500 mg/l, and a liquid pH is in the range of 7 to 14.

3. The copper-plating solution according to claim 1, further comprising a surfactant as an additive.

4. A copper-plating solution comprising monovalent or divalent copper ions, a complexing agent, and an organic sulfur compound as an additive.

5. The copper-plating solution according to claim 4, wherein the concentration of said copper ions is in the range of 0.1 to 100 g/l, the concentration of said complexing agent is in the range of 0.1 to 500 g/l, the concentration of said organic sulfur compound is in the range of 0.1 to 500 mg/l, and a liquid pH is in the range of 7 to 14.

6. The copper-plating solution according to claim 4, further comprising a surfactant as an additive.

7. The copper-plating solution according to claim 4, wherein said organic sulfur compound is one or more kinds of organic sulfide compounds or organic polysulfide compounds.

8. A method for plating a substrate having fine recesses covered with a seed layer to fill the fine recesses with a metal, comprising plating a surface of the substrate by bringing the surface of the substrate into contact with a plating solution, said plating solution comprising monovalent or divalent copper ions, a complexing agent, and an organic sulfur compound as an additive.

9. The method according to claim 8, wherein said plating solution has a copper ion concentration in the range of 0.1 to 100 g/l, a complexing agent concentration in the range of 0.1 to 500 g/l and an organic sulfur compound concentration in the range of 0.1 to 500 mg/l, and has a liquid pH in the range of 7 to 14.

10. The method according to claim 8, wherein said plating solution further comprises a surfactant as an additive.

11. The method according to claim 8, wherein said organic sulfur compound in said plating solution is one or more kinds of organic sulfide compounds or organic polysulfide compounds.

12. A method for plating a substrate having fine recesses covered with a barrier layer to fill the fine recesses with a metal, comprising plating a surface of the substrate by bringing the surface of the substrate into contact with a plating solution, said plating solution comprising monovalent or divalent copper ions, a complexing agent, and an organic sulfur compound as an additive.

13. The method according to claim 12, wherein said plating solution has a copper ion concentration in the range of 0.1 to 100 g/l, a complexing agent concentration in the range of 0.1 to 500 g/l and an organic sulfur compound concentration in the range of 0.1 to 500 mg/l, and has a liquid pH in the range of 7 to 14.

14. The method according to claim 12, wherein said plating solution further comprises a surfactant as an additive.

15. The method according to claim 12, wherein said organic sulfur compound in said plating solution is one or more kinds of organic sulfide compounds or organic polysulfide compounds.

16. A method for plating a substrate having fine recesses covered with a seed layer to fill the fine recesses with a metal, comprising:
plating the surface of the substrate in a first-stage by bringing a surface of the substrate into contact with a first plating solution; and
plating the surface of the substrate in a second-stage by bringing the surface of the substrate into contact with a second plating solution;
wherein said first plating solution comprises monovalent or divalent copper ions, a complexing agent, and an organic sulfur compound as an additive, and said second plating solution has a composition of excellent leveling properties.

17. The method according to claim 16, wherein, said first plating solution has a copper ion concentration in the range of 0.1 to 100 g/l, a complexing agent concentration in the range of 0.1 to 500 g/l and an organic sulfur compound concentration in the range of 0.1 to 500 mg/l, and has a liquid pH in the range of 7 to 14.

18. The method according to claim 16, wherein said first plating solution further comprises a surfactant as an additive.

19. The method according to claim 16, wherein said organic sulfur compound in said first plating solution is one or more kinds of organic sulfide compounds or organic polysulfide compounds.

20. A method for plating a substrate having fine recesses covered with a barrier layer to fill the fine recesses with a metal, comprising:
plating the surface of the substrate in a first-stage by bringing a surface of the substrate into contact with a first plating solution; and
plating the surface of the substrate in a second-stage by bringing the surface of the substrate into contact with a second plating solution;
wherein said first plating solution comprises monovalent or divalent copper ions, a complexing agent, and an organic sulfur compound as an additive, and said second plating solution has a composition of excellent leveling properties.

21. The method according to claim 20, wherein said first plating solution has a copper ion concentration in the range of 0.1 to 100 g/l, a complexing agent concentration in the range of 0.1 to 500 g/l and an organic sulfur compound concentration in the range of 0.1 to 500 mg/l, and has a liquid pH in the range of 7 to 14.

22. The method according to claim 20, wherein said first plating solution further comprises a surfactant as an additive.

23. The method according to claim 20, wherein said organic sulfur compound in said first plating solution is one or more kinds of organic sulfide compounds or organic polysulfide compounds.

24. A plating apparatus, comprising:
a first plating section for carrying out a first-stage plating of a surface of a substrate having fine recesses covered with a barrier layer and/or a seed layer;
a first plating solution feed section for feeding a first plating solution into a plating chamber in said first plating section;
a second plating section for carrying out a second-stage plating of the surface of the substrate which has undergone said first-stage plating;
a second plating solution feed section for feeding a second plating solution into a plating chamber in said second plating section; and
a transfer section for transferring the substrate from said first plating section to said second plating section;
wherein said first plating solution has a composition of excellent uniform electrodeposition properties and comprises monovalent or divalent copper ions, a complexing agent, and an organic sulfur compound as an additive, and said second plating solution has a composition of excellent leveling properties.

25. The plating apparatus according to claim 24, wherein said first plating solution has a copper ion concentration in the range of 0.1 to 100 g/l, a completing agent concentration in the range of 0.1 to 500 g/l and an organic sulfur compound concentration in the range of 0.1 to 500 mg/l, and has a liquid pH in the range of 7 to 14.

26. The plating apparatus according to claim 24, wherein said first plating solution further comprises a surfactant as an additive.

27. The plating apparatus according to claim 24, wherein said organic sulfur compound in said first plating solution is one or more kinds of organic sulfide compounds or organic polysulfide compounds.
